(19) United States
(12) Patent Application Publication
(10) Pub. No.: US 2023/0186330 A1
(43) Pub. Date: Jun. 15, 2023

(54) DETERMINING CUSTOMIZED CONSUMPTION CADENCES FROM A CONSUMPTION CADENCE MODEL

(71) Applicant: Adobe Inc., San Jose, CA (US)

(72) Inventors: Michele Saad, Austin, TX (US); Lauren Dest, Austin, TX (US)

(21) Appl. No.: 17/517,462

(22) Filed: Nov. 2, 2021

(51) Int. Cl. G06Q 30/02; G06Q 30/06; G06N 3/04

(52) U.S. Cl. CPC G06Q 30/0202; G06N 3/04; G06Q 30/0643

(57) ABSTRACT

This disclosure describes one or more implementations of systems, non-transitory computer-readable media, and methods that utilize a consumption cadence model to predict customized consumption cadences for user accounts across a wide variety of consumable items and generate dynamic selectable consumption scheduling options for the consumable items using the customized consumption cadences. For example, the disclosed systems predict a consumption cadence for consuming a consumable item that is customized for a user account that interacted with the consumable item. Additionally, in some embodiments, the disclosed systems utilize collective user behavior from user accounts that are similar to the user account to determine a predicted consumption cadence using a consumption cadence model. After determining such a cadence, in some instances, the disclosed systems also display a dynamic selectable scheduling option within a graphical user interface according to the predicted consumption cadence for the consumable item.

### BACKGROUND

In recent years, conventional digital exchange systems increasingly provide options for selecting reoccurring consumption events for digital content or other products on mobile applications and websites. Indeed, conventional computing devices for content applications and websites can generate graphical user interfaces to provide options to schedule a reoccurring consumption of a product or a service—at fixed intervals offered to every computing device that accesses the application or website. Oftentimes, upon facilitating a consumption event for a user account on a mobile application or website, many conventional digital exchange systems display options to schedule the same consumption event on a reoccurring basis in the future such that the consumption event is automatically fulfilled by the system at each reoccurring scheduled time. Although these conventional digital exchange systems can provide a number of configurable options to schedule reoccurring consumption events, as explained further below, they have a number of technical shortcomings, such as by providing rigid, one-size-fits-all options for cadence consumption and providing such cadence consumption options based on selections from preset consumption schedules.

### SUMMARY

This disclosure describes embodiments of systems, computer-readable media, and methods that solve the foregoing problems and provide other benefits. For instance, the disclosed systems utilize a consumption cadence model to predict customized consumption cadences for user accounts across a variety of consumable items and generate dynamic selectable consumption scheduling options for the consumable items using the customized consumption cadences. In particular, in some cases, the disclosed systems predict a consumption cadence for consuming a consumable item with a cadence that is customized for a user account. For example, the disclosed systems utilize the history of the user account’s previous consumption of the consumable item or collective user behavior from user accounts that are similar to the user account to determine a predicted consumption cadence using a consumption cadence model. After determining such a cadence, in some instances, the disclosed systems also display a dynamic selectable scheduling option within a graphical user interface according to the predicted consumption cadence for the consumable item.

In addition to customizing a consumption cadence for a user account, in some embodiments, the disclosed systems utilize the consumption cadence model to determine a consumption cadence customized for a target time frame (e.g., a particular season). In addition, the disclosed systems can also utilize relationships between multiple consumable items to determine a predicted consumption cadence for at least one of the consumable items when multiple consumable items are consumed together or otherwise related (e.g., shampoo and conditioner). By utilizing the consumption cadence model to determine customized consumption cadences for a particular user account and a target time frame—and dynamically displaying selectable options for the customized consumption cadences—the disclosed systems provide flexible graphical interface features to dynamically schedule consumption of consumable items utilizing accurately predicted consumption cadences.

### BRIEF DESCRIPTION OF THE DRAWINGS

The detailed description is described with reference to the accompanying drawings in which:

FIG. 1 illustrates a schematic diagram of an example system in which a consumption cadence modeling system operates in accordance with one or more implementations.

FIG. 2 illustrates an overview of a consumption cadence modeling system determining a predicted consumption cadence in accordance with one or more implementations.

FIG. 3 illustrates a consumption cadence modeling system determining a predicted consumption cadence utilizing a consumption cadence model based on historical user consumption data related to a consumable item in accordance with one or more implementations.

FIG. 4 illustrates a consumption cadence modeling system determining a predicted consumption cadence utilizing a consumption cadence model based on historical user consumption data related to multiple consumable items in accordance with one or more implementations.

FIG. 5 illustrates a consumption cadence modeling system displaying an indicator for a predicted consumption cadence and selectable options for a predicted consumption cadence in accordance with one or more implementations.

FIGS. 6A and 6B illustrate a consumption cadence modeling system updating an indicator that presents a predicted consumption cadence in accordance with one or more implementations.

FIG. 7 illustrates a consumption cadence modeling system modifying a predicted consumption cadence based on user interactions corresponding to a user account in accordance with one or more implementations.

FIG. 8 illustrates a consumption cadence modeling system displaying a graphic that compares a predicted consumption cadence to a generic consumption cadence in accordance with one or more implementations.

FIG. 9 illustrates a consumption cadence modeling system transmitting an electronic communication with a predicted consumption cadence in accordance with one or more implementations.

FIG. 10 illustrates a schematic diagram of a consumption cadence modeling system in accordance with one or more implementations.

FIG. 11 illustrates a flowchart of a series of acts for determining a predicted consumption cadence utilizing a consumption cadence model in accordance with one or more implementations.

FIG. 12 illustrates a block diagram of an example computing device in accordance with one or more implementations.

### DETAILED DESCRIPTION

The disclosure describes one or more embodiments of a consumption cadence modeling system that determines, utilizing a consumption cadence model, a consumption cadence for a consumable item that is customized for a user account and generate graphical user interfaces with dynamic selectable consumption scheduling options for the consumable item using the customized consumption cadence. For example, the consumption cadence modeling system detects a user interaction with a consumable item from a user account. Based on comparisons to user attributes associated with the user account, the consumption cadence modeling system identifies one or more users that previously consumed the consumable item. In some cases, such a user may be the user account interacted with the consumable item. The consumption cadence modeling system subsequently utilizes a consumption cadence model with historical user consumption data of the identified users to determine a predicted consumption cadence that is customized for the user account to consume the consumable item. The consumption cadence modeling system further displays, within a graphical user interface of a client device associated with the user account, an indicator of the predicted consumption cadence and a selectable option to schedule consumption of the consumable item according to the predicted consumption cadence.

In one or more embodiments, the consumption cadence modeling system utilizes the consumption cadence model to analyze a set of historical user consumption data (e.g., as aggregated data) from the identified users that have previously consumed the consumable item. For example, the consumption cadence modeling system can utilize a subset of historical user consumption data from the identified users that have consumed the consumable item during a target time frame that corresponds to the interaction time of the user account (e.g., summer when a client device interacts with the consumable item during or before summer). By doing so, the consumption cadence modeling system determines customized consumption cadences for a user account that can vary according to the time at which a client device interacts with a graphical representation of a consumable item or a time otherwise selected by the client device.

As mentioned above, in one or more embodiments, the consumption cadence modeling system identifies a user interaction with a consumable item. For instance, in one or more embodiments, the consumption cadence modeling system detects a user interaction with a graphical representation of a consumable item within a graphical user interface. In certain instances, the user interaction includes a selection of the consumable item to initiate a purchase of the consumable item and/or to access the consumable item. Moreover, in some embodiments, the consumption cadence modeling system identifies an interaction time corresponding to the user interaction with the graphical representation of the consumable item, such as a date and time that falls within a particular season.

In addition to identifying such a user interaction, in one or more embodiments, the consumption cadence modeling system identifies one or more users that have previously consumed the consumable item based on one or more user attributes that correspond to the user of the user account. In some instances, the consumption cadence modeling system identifies the user of the user account that has previously consumed the consumable item when the user has a history of consuming the consumable item. Furthermore, in one or more embodiments, the consumption cadence modeling system first identifies users that have previously consumed the consumable item by utilizing historical user consumption data of the users. Then, in some cases, the consumption cadence modeling system identifies a subset of users (from the users that previously consumed the consumable item) that are similar to the user account based on a comparison of user attributes corresponding to the users and the user associated with the user account. For example, the consumption cadence modeling system utilizes user attributes such as, but not limited to demographic data, geographic data, time-zone data, consumption history data, and/or client device information corresponding to the user of the user account to identify the subset of similar users. Indeed, in one or more embodiments, the consumption cadence modeling system identifies users for the subset of users that correspond to one or more of the user attributes associated with the user of the user account.

As also mentioned above, in some instances, the consumption cadence modeling system utilizes a consumption cadence model to determine a predicted consumption cadence customized for the user account to consume the consumable item. For instance, in some embodiments, the consumption cadence modeling system determines the predicted consumption cadence for the user account based on historical user consumption data (e.g., a time of consumption, a quantity of consumption) of the identified user or users consuming the consumable item. Furthermore, in some embodiments, the consumption cadence modeling system also identifies historical user consumption data of the user corresponding to the user account for the consumption cadence model. For example, in some instances, the consumption cadence modeling system utilizes a machine-learning-based consumption cadence model to analyze the historical user consumption data and generate a predicted consumption cadence. By contrast, in some instances, the consumption cadence modeling system generates (or calculates) a predicted consumption cadence by mathematically evaluating the historical user consumption data (e.g., an average, a moving average, a median).

Additionally, in some embodiments, the consumption cadence modeling system determines a customized consumption cadence for not only a user account but for a target time frame. In some instances, the target time frame represents, but is not limited to, a spring season, a summer season, an autumn season, or a winter season. Moreover, in some instances, the consumption cadence modeling system also selects a subset of historical user consumption data of users previously consuming the consumable item during the target time frame to determine a predicted consumption cadence customized for the user account to consume the consumable item.

As suggested above, some consumable items are consumed together or on a related cadence. In certain embodiments, the consumption cadence modeling system detects user interactions with graphical representations of multiple consumable items (e.g., a first and second consumable item). Moreover, in some instances, the consumption cadence modeling system identifies users that have previously consumed both a first consumable item and a second consumable item within a threshold time frame and are associated with user attributes that correspond to the user of the user account. Indeed, in one or more embodiments, the consumption cadence modeling system determines the predicted consumption cadence to consume the first consumable item (and/or the second consumable item) customized for the user of the user account based on historical user consumption data of the users that have previously consumed both the first consumable item and the second consumable item.

Upon determining the predicted consumption cadence of one or more consumable items, the consumption cadence modeling system displays dynamic indicators and/or selectable options within a graphical user interface for graphical representations of the consumable item(s) utilizing the predicted consumption cadence. For example, the consumption cadence modeling system displays indicators that display the predicted consumption cadence customized for the user account (according to a target time frame). In some instances, the consumption cadence modeling system dynamically updates the indicator to visualize changes in the predicted consumption cadence (e.g., based on updated user consumption data from users and/or the user corresponding to the user account).

In one or more embodiments, the consumption cadence modeling system also displays selectable options for the predicted consumption cadence or to alter the predicted consumption cadence. As an example, the consumption cadence modeling system displays a selectable option to schedule consumption of the consumable item according to the predicted consumption cadence. In some instances, the consumption cadence modeling system also displays selectable options to skip, cancel, and/or pause a scheduled consumption of the consumable item that is based on the predicted consumption cadence. Upon receiving a user interaction with one or more selectable options, the consumption cadence modeling system can modify the predicted consumption cadence (or a subsequent predicted consumption cadence) based on the received user interactions. For example, in some embodiments, the consumption cadence modeling system utilizes the received user interactions as a feedback loop for the consumption cadence model to determine updated consumption cadence predictions that account for the user interactions with previous consumption cadence predictions.

As suggested above, many conventional digital exchange systems fail to provide flexible graphical user interface options that account for a wide variety of consumption rates across a large number of consumable items that may exist in a consumable item database. To illustrate, many conventional systems display rigid, default consumption cadence options that do not change based on the consumable item or user behavior. In particular, many conventional systems implement heuristic computing models that utilize preset (or default) consumption cadences that are the same across users and across consumable items—without customization for a particular user account or a particular time frame.

In addition to preset consumption cadences, some conventional analytics systems use heuristic computing models that rigidly present cadences for consumption events based on user selections of preset consumption schedules. Oftentimes, conventional analytics systems utilize a most common user selection approach to determine cadences for consumption events. Although these approaches determine the most commonly scheduled consumption cadence for a consumable item, such conventional systems fail to (and lack dynamic computing models for) accurately determine consumption cadences that are personalized for specific (and individual) user behavior.

The disclosed consumption cadence modeling system provides several advantages over conventional digital exchange systems by determining a consumption cadence for a consumable item that is customized for a user utilizing a consumption cadence model that accounts for user behavioral changes across different time frames. For example, the consumption cadence modeling system provides flexible graphical user interface options that can dynamically change for a wide variety of consumption rates across a large number of consumable items—depending on the particular user account and/or target time frame. Unlike conventional systems that utilize rigid and default consumption cadence scheduling options, the consumption cadence modeling system can determine predicted consumption cadences that are customized for a user and for a particular consumable item.

Moreover, the consumption cadence modeling system also accounts for target time frames (derived from interaction times with a consumable item or other user interactions) to determine predicted consumption cadences that change to reflect temporal user behavior changes of the target time frame. As an example, the consumption cadence modeling system determines predicted consumption cadences and presents options for the consumption cadences that are specific (or dynamically change according to) an interaction time and an identified target time frame. In addition to dynamic options, the consumption cadence modeling system also displays graphics that compare generic cadences and customized cadences to improve the accessible information available on a graphical user interface from computationally modeled consumption cadences. Accordingly, the consumption cadence modeling system can provide dynamic options within a graphical user interface that change based on time frame, consumable item, user behavior, and/or interactions with multiple consumable items.

In addition to a unique customization computing model, unlike the rigid one-size-fits-all cadences of conventional digital exchange systems, the consumption cadence modeling system can intelligently (and accurately) determine consumption cadences for a large number of consumable items and diverse interaction behaviors per consumable item and per user. For example, by leveraging historical user consumption data that is specifically identified for a user that interacted with a consumable item, an interaction time, and user attributes, the consumption cadence modeling system accurately determines consumption cadences for individual consumable items that are customized for individual users and account for temporal behaviors. Unlike conventional digital exchange systems that fail to accurately utilize unwieldy and complex user behavioral data for a large number of consumable items and rather only determine commonly selected scheduling options, the consumption cadence modeling system utilizes a consumption cadence model to analyze the selected combination of data to determine an accurate and personalized consumption cadence for a user in relation to a specific consumable item.

As indicated by the foregoing discussion, this disclosure describes various features and advantages of the consumption cadence modeling system. As used in this disclosure, the term “consumable item” refers to a physical or virtual item that can be purchased, exchanged, or otherwise consumed. For instance, a consumable item includes a digital content item, an object, and/or a service that is graphically represented on a graphical user interface. In particular, in some embodiments, a consumable item includes a digital content item (e.g., a digital image, a digital video, an in-game item or downloadable content such as a DLC, an electronic document such as a PDF, web article, and/or e-mail) that is purchasable and/or subscribed to via a computing device (e.g., on a mobile application and/or web interface). In addition, in some instances, a consumable item as an object also includes a product (e.g., a physical and deliverable product) that is purchasable and/or subscribe to via the computing device. Moreover, in some embodiments, a consumable item includes a service (e.g., a streaming service, an application service, a cloud service, a delivery service) that is initiated via selection (or purchase) through a computing device.

As further used in this disclosure, the term “user interaction with a graphical representation of a consumable item” refers to a user input to interact with a consumable item presented on a graphical user interface. For example, a user interaction with a graphical representation of a consumable item includes a selection, touch gesture, cursor hover, initiation, and/or other digital interaction with of the consumable item via one or more selections associated with the graphical representation of the consumable item. In some cases, a user interaction with a graphical representation of a consumable item includes a user input indicating a request to consume the consumable item (e.g., consumption).

As used herein, the term “consumption” refers to purchasing, downloading, playing, and/or accessing a consumable item. For instance, a consumption includes, but is not limited to, an online product purchase of a consumable item, an online digital video purchase of a consumable item, and/or an online subscription enrollment for a consumable item.

Furthermore, as used in this disclosure, the term “consumption cadence” refers to a pattern or time interval at which a consumable item is consumed. For instance, a consumption cadence includes a repeated interval or duration of time between consumption of a consumable item over a time period. To illustrate, a consumption cadence indicates a time between a consumption of a consumable item and a subsequent consumption of the consumable item (e.g., every 2 months, every 7 weeks, every 10 days).

Moreover, as used in this disclosure, the term “user consumption data” refers to information representing user activities and/or interactions (e.g., consumptions, cancellations, views) with one or more consumable items. For example, user consumption data includes, but is not limited to, a number of times a user consumes a particular consumable item, the quantity of consumable items of a particular type consumed, times (or dates) of consumption, a consumption frequency, consumable items interacted with by a user, and/or saved (or bookmarked) consumable items. In addition, in some embodiments, user consumption data also includes interactions with predicted consumption cadences and/or scheduled consumption cadences. For instance, the user consumption data includes, but is not limited to, an acceptance of a consumption cadence, a cancellation of a scheduled consumption based on a predicted consumption cadence, and/or a modification of a scheduled consumption based on a predicted consumption cadence.

Additionally, as used herein, the term “user attribute” refers to information representing characteristics and/or a profile of a user (or user account). For instance, user attribute includes demographic data, geographic data, time-zone data, consumption history, client device information, and/or preferences of a user. As an example, a user attribute includes, but is not limited to, a location of a user, a gender of a user, an age of a user, a language of a user, and/or hobbies (or interests) of a user.

Moreover, as used herein, the term “time frame” refers to a range of time. In particular, in one or more embodiments, a time frame includes a range of time with a start and an end. For instance, a time frame includes, but is not limited to, seasons (e.g., fall, winter, spring, summer), holidays (e.g., Thanksgiving weekend, Memorial Day weekend), a range within a week (e.g., weekend, business days), and/or another event (e.g., a Football season, Basketball season, fishing season, skiing season).

As used in this disclosure, the term “consumption cadence model” refers to a model that determines (and/or outputs) a consumption cadence for a user of a user account in relation to a consumable item. For instance, a consumption cadence model includes a machine learning model and/or an algorithm that utilizes user consumption data to infer (or determine) a predicted consumption cadence of a user consuming a particular consumable item. In some instances, the consumption cadence model calculates an average consumption cadence for a consumable item based on historical user consumption data of one or more users consuming the consumable item as the predicted consumption cadence.

In certain implementations, the consumption cadence model includes a machine learning model that generates a predicted consumption cadence for a consumable item based on an analysis of historical user consumption data of one or more users consuming the consumable item. For example, as used herein, the term “machine learning model” refers to a computer algorithm or a collection of computer algorithms that automatically improve for a particular task through experience based on use of data. For example, a machine learning model utilizes one or more learning techniques to improve in accuracy and/or effectiveness. Example machine learning models include various types of decision trees, support vector machines, Bayesian networks, linear regressions, logistic regressions, random forest models, time series model, pairwise products model, or neural networks. Indeed, in some instances, a machine learning model includes a long short-term memory model, a convolutional neural network (CNN) model, or a recurrent neural network (RNN) model.

Furthermore, as used herein, the term “neural network” refers to a machine learning model that can be tuned (e.g., trained) based on training input to approximate unknown functions. For example, a neural network includes a model of interconnected digital neurons that communicate and learn to approximate complex functions and generate outputs based on a plurality of inputs provided to the model. For instance, a neural network includes one or more machine learning algorithms such as, but not limited to, a CNN or an RNN.

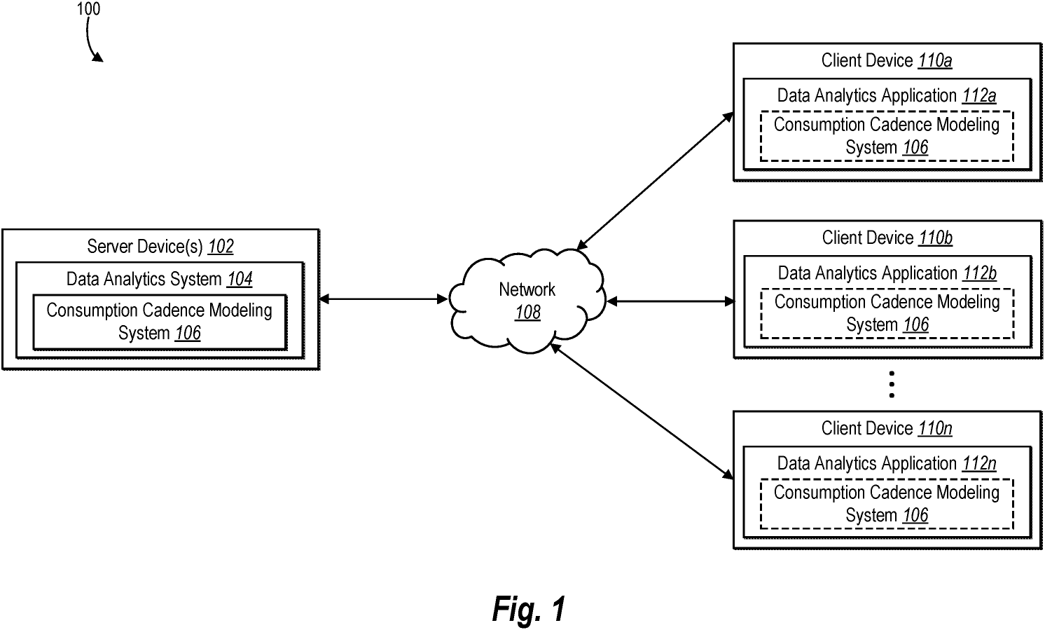

Turning now to the figures, FIG. 1 illustrates a schematic diagram of one embodiment of a system 100 (or environment) in which a consumption cadence modeling system 106 operates in accordance with one or more embodiments. As illustrated in FIG. 1, the system 100 includes server device(s) 102, a network 108, and client devices 110a-110n. As further illustrated in FIG. 1, the server device(s) 102 and the client devices 110a-110n communicate via the network 108.

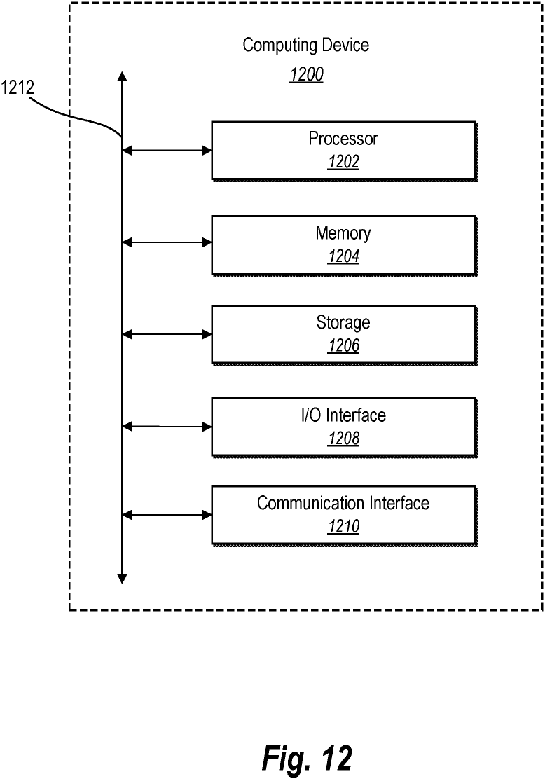

As shown in FIG. 1, the server device(s) 102 include a data analytics system 104 which further includes the consumption cadence modeling system 106. For instance, the server device(s) 102 includes, but is not limited to, a computing (or computer) device (as explained below with reference to FIG. 12). In one or more embodiments, the consumption cadence modeling system 106 determines a consumption cadence for a consumable item that is customized for a user utilizing a consumption cadence model. For example, the consumption cadence modeling system 106 detects a user interaction with a consumable item and identifies users that previously consumed the consumable item (based on user attributes). Moreover, in one or more instances, the consumption cadence modeling system 106 utilizes a consumption cadence model with historical user consumption data of the identified users to determine a predicted consumption cadence. Subsequently, in certain instances, the consumption cadence modeling system 106 generates graphical user interfaces to present dynamic selectable consumption scheduling options for the consumable item using the predicted consumption cadence.

Additionally, as shown in FIG. 1, the system 100 includes the client devices 110a-110n. In some embodiments, the client devices 110a-110n may include, but are not limited to, a mobile device (e.g., a smartphone, tablet), a laptop, a desktop, or another type of computing device as described below with reference to FIG. 12. In one or more embodiments, users of the client devices 110a-110n can interact with platforms (e.g., website, application, digital service) to provide user data (or interactions) to the server device(s) 102 (e.g., user interactions with representations of consumable items, user consumption data, and/or user interactions with user interface elements). Moreover, the client devices 110a-110n can receive and display graphical user interfaces (via the consumption cadence modeling system 106) for consumable items, information of predicted consumption cadences, and/or selectable options for the predicted consumption cadences.

To illustrate, in some instances, the client device 110a displays a representation of a consumable item within a graphical user interface (e.g., within an e-commerce website, an email). Then, in some embodiments, upon receiving a user interaction with the consumable item (e.g., a purchase request, a subscribe request, a save request) from the client device 110a, the consumption cadence modeling system 106 determines, utilizing a consumption cadence model, a predicted consumption cadence for the consumable item that is customized for a user (e.g., a determination that the user of the client device 110a will purchase the consumable item at a determined cadence that represents a time interval). In addition, in one or more embodiments, the consumption cadence modeling system 106 provides, for display within a graphical user interface of the client device 110a, an indicator for the determined consumption cadence and/or a selectable option to schedule consumption of the consumable item according to the predicted consumption cadence.

To access the functionalities of the consumption cadence modeling system 106 (as described above), in some implementations, users interact with the data analytics applications 112a-112n on the client devices 110a-110n. For instance, the data analytics applications 112a-112n includes one or more software applications (e.g., interact with graphic representations of consumable items and predicted consumption cadences shown in a software application) installed on the client devices 110a-110n. In certain instances, the data analytics applications 112a-112n are hosted on the server device(s) 102. In addition, when hosted on the server device(s), the data analytics application 112a-112n is accessed by the client devices 110a-110n through web browsers and/or other online interfacing platforms and/or tools.

In some implementations, the consumption cadence modeling system 106 on the server device(s) 102 supports the consumption cadence modeling system 106 on the client devices 110a-110n. For example, the consumption cadence modeling system 106 on the server device(s) 102 provides the consumption cadence model to the client devices 110a-110n. In other words, the client devices 110a-110n obtain (e.g., download) the consumption cadence modeling system 106 with a consumption cadence model from the server device(s) 102. Once downloaded, the consumption cadence modeling system 106 on the client devices 110a-110n utilizes the consumption cadence modeling system 106 to determine predicted consumption cadences for a user in accordance with one or more implementations herein.

In alternative implementations, the consumption cadence modeling system 106 includes a web hosting application that allows the client devices 110a-110n to interact with content and services hosted on the server device(s) 102. To illustrate, in one or more implementations, the client devices 110a-110n access a web page supported by the server device(s) 102. The client devices 110a-110n provide a user interaction with a representation of a consumable item to the server device(s) 102 (via the web hosting application), and, in response, the consumption cadence modeling system 106 on the server device(s) 102 determines predicted consumption cadences in accordance with one or more implementations herein. The server device(s) 102 then provides an indicator (and/or selectable options) for the determined predicted consumption cadences to the client devices 110a-110n for display or further interaction.

Indeed, the consumption cadence modeling system 106 can be implemented in whole, or in part, by the individual elements of the system 100. Although FIG. 1 illustrates the consumption cadence modeling system 106 implemented with regard to the server device(s) 102, different components of the consumption cadence modeling system 106 can be implemented by a variety of devices within the system 100. For example, as mentioned above, the consumption cadence modeling system 106 is, in some cases, implemented on the client devices 110a-110n.

Additionally, as shown in FIG. 1, the system 100 includes the network 108. As mentioned above, in some embodiments, the network 108 enables communication between components of the system 100. In certain embodiments, the network 108 includes a suitable network and may communicate using any communication platforms and technologies suitable for transporting data and/or communication signals, examples of which are described with reference to FIG. 12. Furthermore, although FIG. 1 illustrates the server device(s) 102 and the client devices 110a-110n communicating via the network 108, in certain embodiments, the various components of the system 100 communicate and/or interact via other methods (e.g., the server device(s) 102 and the client devices 110a-110n communicating directly).

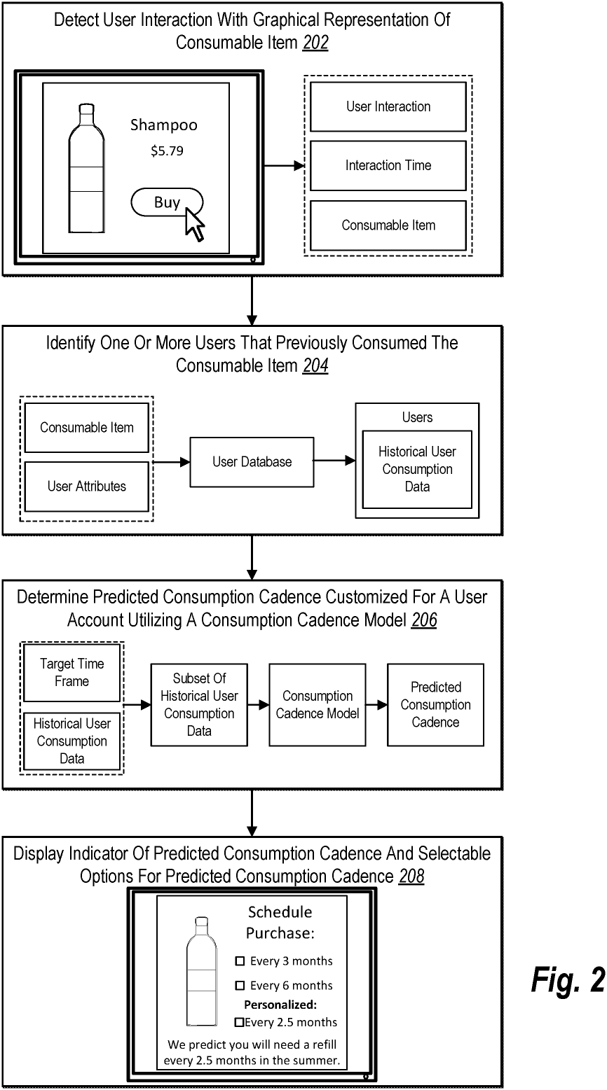

As previously mentioned, in one or more embodiments, the consumption cadence modeling system 106 determines, utilizing a consumption cadence model, a consumption cadence for a consumable item that is customized for a user and generate graphical user interfaces to present dynamic selectable consumption scheduling options for the consumable item using the customized consumption cadence. Indeed, FIG. 2 illustrates an example of the consumption cadence modeling system 106 determining a predicted consumption cadence for a consumable item. Moreover, FIG. 2 also illustrates an example of the consumption cadence modeling system 106 displaying dynamic selectable consumption scheduling options using the predicted consumption cadence for the consumable item.

To illustrate, as shown in FIG. 2, the consumption cadence modeling system 106 detects a user interaction with a graphical representation of a consumable item in an act 202. For instance, upon detecting a user interaction in the act 202, the consumption cadence modeling system 106 identifies a user interaction, an interaction time, and a consumable item from the user interaction with the graphical representation of the consumable item. As further shown in the act 202 of FIG. 2, the graphical representation of the consumable item is presented within a client device and the consumption cadence modeling system 106 detects (or receives) a user interaction with the represented consumable item from the client device.

As further illustrated in FIG. 2, the graphical representation of the consumable item in the act 202 is within a graphical user interface of an e-commerce web application (and/or website). In particular, in one or more embodiments, the consumption cadence modeling system 106 identifies interactions with consumable items within an e-commerce web application (and/or website) that facilitate the presentation of consumable items and the purchase of consumable items. Although one or more embodiments herein describe the consumption cadence modeling system 106 identifying interactions with consumable items within an e-commerce web application, the consumption cadence modeling system 106, in some embodiments, identifies interactions with consumable items within a variety of applications and/or user interfaces including, but not limited to, emails, digital content platforms (e.g., digital music platforms, digital book platforms, digital audio book platforms) streaming services, cloud services, and/or other digital subscription services (e.g., digital newspaper, digital magazine, digital food delivery service).

In addition, in one or more embodiments, the consumption cadence modeling system 106 identifies a user interaction (e.g., as shown in the act 202 of FIG. 2) with a consumable item. In certain instances, the consumption cadence modeling system 106 identifies a request to consume the consumable item as a user interaction. As an example, the consumption cadence modeling system 106 identifies request to consume that indicates a user purchase request for the consumable item (e.g., a product and/or digital content). In some embodiments, the consumption cadence modeling system 106 identifies user interactions that indicate a consumption of a consumable item, such as, but not limited to, a download (e.g., a digital content download, an application download), a subscription plan initiation, a request to access a digital content item (e.g., a digital video stream, digital image, electronic document such as a book and/or news article). In some cases, the consumption cadence modeling system 106 identifies a user interaction to indicate a consumption of the consumable item by identifying interactions, such as, but not limited to, a request to save a consumable item, a request to rate a consumable item, a request to access a consumable item, and/or a request to schedule a future consumption of a consumable item.

In addition to the user interaction, as shown in the act 202 of FIG. 2, the consumption cadence modeling system 106 identifies the consumable item corresponding to the user interaction. For instance, as mentioned above, a consumable item can include a digital content item, a product, and/or service that is consumed (e.g., purchased, subscribed to, and/or accessed) by a user via a client device. In some embodiments, the consumption cadence modeling system 106 also detects user interactions indicating consumption of multiple consumable items from a client device of a user account.

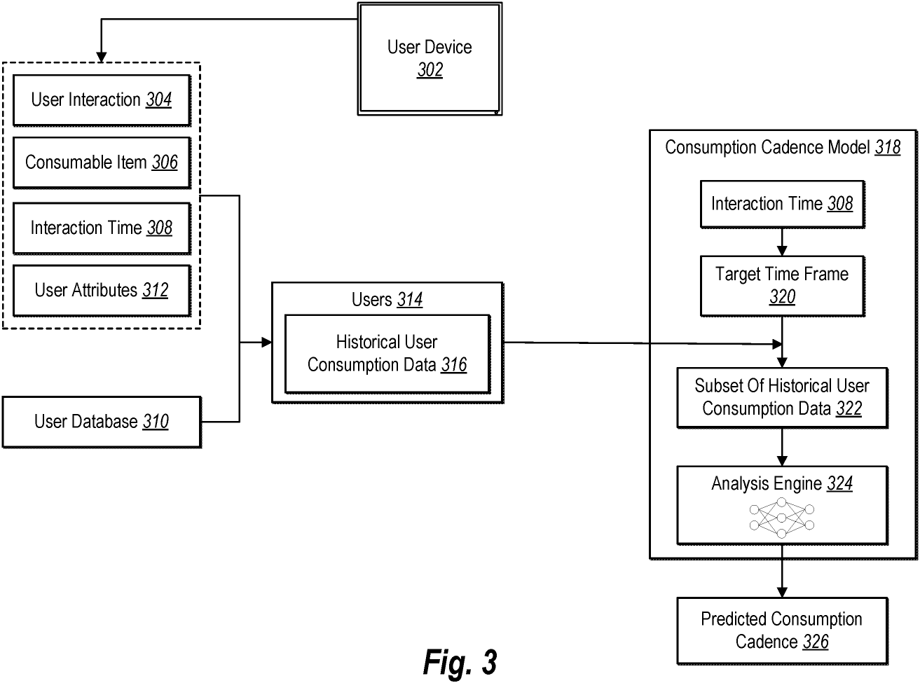

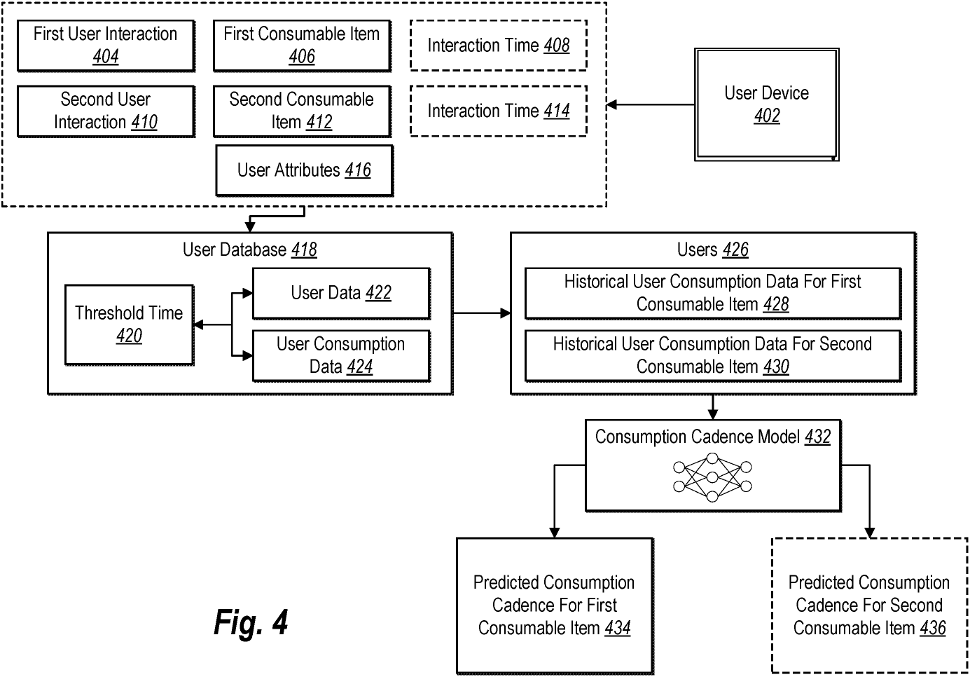

Furthermore, as shown in the act 202 of FIG. 2, the consumption cadence modeling system 106 identifies an interaction time corresponding to the user interaction. In one or more embodiments, the interaction time indicates the time that a client device of a user account interacts with a graphical representation of a consumable item. Indeed, in one or more embodiments, the interaction time includes a time and a date of interaction. In some instances, the consumption cadence modeling system 106 utilizes the interaction time to determine a target time frame for the consumption user data to utilize with a consumption cadence model as described in greater detail below (e.g., in relation to FIGS. 3 and 4).

As further shown in act 204 of FIG. 2, the consumption cadence modeling system 106 identifies one or more users that previously consumed the consumable item. For instance, as shown in the act 204 of FIG. 2, the consumption cadence modeling system 106 utilizes the detected consumable item (from the act 202) and user attributes of the user corresponding to the user interaction (from the act 202) to identify one or more users from a user database. In particular, in one or more embodiments, the consumption cadence modeling system 106 identifies the one or more users from the user database that have previously interacted with (e.g., consumed) the consumable item. Furthermore, in some embodiments, the consumption cadence modeling system 106 also selects users that are associated to one or more of the user attributes of the user that corresponds to the user interaction (from the act 202) (e.g., similar to the user).

As shown in the act 204 of FIG. 2, the consumption cadence modeling system 106 identifies one or more users and historical user consumption data for the one or more users from a user database. In one or more embodiments, the one or more users and the historical user consumption data includes the user corresponding to the user interaction (from the act 202) and historical user consumption data corresponding to this user. This disclosure describes the consumption cadence modeling system 106 identifying users and historical user consumption data in greater detail below (e.g., in relation to FIGS. 3 and 4).

Additionally, as shown in act 206 of FIG. 2, the consumption cadence modeling system 106 determines a predicted consumption cadence customized for a user account utilizing a consumption cadence model. In particular, as shown in the act 206 of FIG. 2, the consumption cadence modeling system 106 determines a target time frame. In some embodiments, the consumption cadence modeling system 106 determines a target time frame from the user interaction time (from the act 202). In addition, as shown in the act 206 of FIG. 2, the consumption cadence modeling system 106 utilizes the target time frame and the historical user consumption data to identify a subset of historical user consumption data that corresponds to interaction times that are within the target time frame. Indeed, by utilizing the subset of historical user consumption data that associates to a selected target time frame based on the user interaction time, the consumption cadence modeling system 106, in one or more embodiments, determines an accurate consumption cadence for the user that accounts for temporal behavior with the consumable item.

Upon identifying the subset of historical user consumption data, as shown in the act 206 of FIG. 2, the consumption cadence modeling system 106 utilizes the subset of historical user consumption data with a consumption cadence model to determine a predicted consumption cadence. In some embodiments, the consumption cadence modeling system 106 utilizes the consumption cadence model to analyze the subset of historical user consumption data to generate a predicted consumption cadence that reflects behavior in the subset of historical user consumption data.

As an example, the consumption cadence modeling system 106 upon a purchase of a consumable item (e.g., a product) by a user of a user account, the consumption cadence modeling system 106 identifies one or more users (including the purchasing user) that have previously purchased the consumable item. Furthermore, in one or more embodiments, the consumption cadence modeling system 106 also utilizes the purchase time to identify a target time frame (e.g., the purchases falling within the summer season). Then, in certain instances, the consumption cadence modeling system 106 identifies a subset of historical user consumption data (e.g., purchases of the consumable item) for the identified users that were initiated within the target time frame (e.g., users and user purchase interactions that correspond to interaction times in the summer). Moreover, in one or more embodiments, the consumption cadence modeling system 106 utilizes the subset of historical user consumption data (e.g., the purchases of the consumable item in the summer) with the consumption cadence model to determine a predicted consumption cadence for the user (e.g., a predicted purchase rate of every 2 weeks for the consumable item during the summer season). This disclosure describes the consumption cadence modeling system 106 utilizing a consumption cadence model with historical user consumption data to determine a predicted consumption cadence for a user in additional detail below (e.g., in relation to FIGS. 3 and 4).

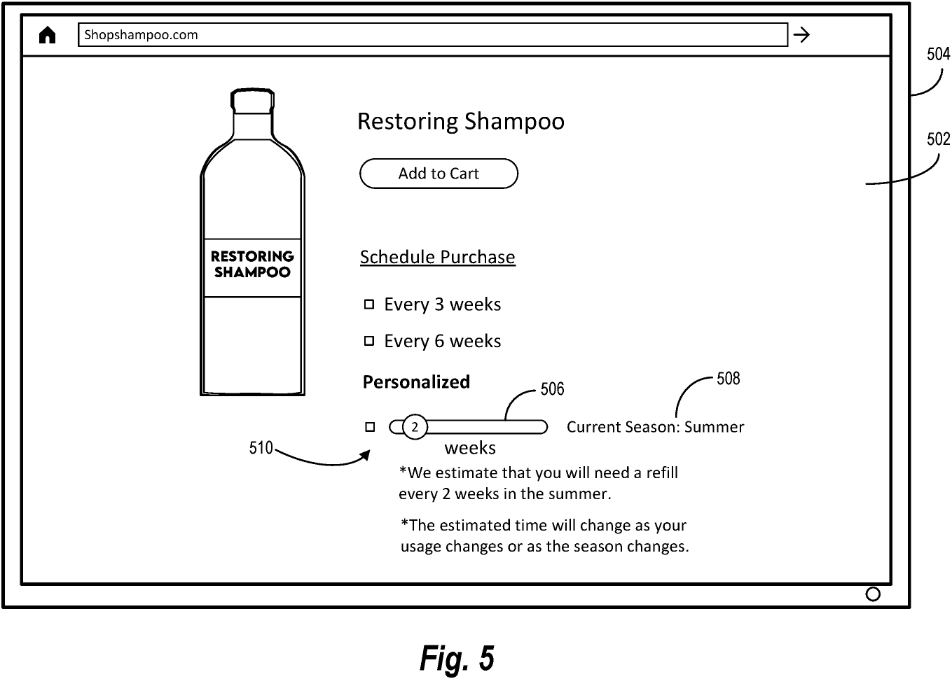

Furthermore, as shown in act 208 of FIG. 2, the consumption cadence modeling system 106 displays an indicator of a predicted consumption cadence and selectable options for the predicted consumption cadence. As illustrated in the act 208 of FIG. 2, the consumption cadence modeling system 106 displays, within a graphical user interface of a client device, an indicator that represents the predicted consumption cadence for the consumable item that is customized for a user (e.g., a specific cadence time interval of “every 2.5 months” to match the user’s behavior with consumption of the consumable item in the target time frame of summer). In addition, as shown in the act 208 of FIG. 2, the consumption cadence modeling system 106 displays a selectable option to schedule consumption of the consumable item according to the predicted consumption cadence. This disclosure describes the consumption cadence modeling system 106 generating user interfaces with dynamic indicators and selectable options for predicted consumption cadences in greater detail below (e.g., in relation to FIGS. 5-9).

As previously mentioned, in one or more embodiments, the consumption cadence modeling system 106 utilizes a consumption cadence model with historical user consumption data to determine a predicted consumption cadence that is customized for a user account to consume a consumable item. For instance, FIG. 3 illustrates the consumption cadence modeling system 106 identifying historical user consumption data. In addition, FIG. 3 also illustrates the consumption cadence modeling system 106 utilizing a consumption cadence model with the historical user consumption data to determine a predicted consumption cadence for a user account.

As shown in FIG. 3, the consumption cadence modeling system 106 identifies a user interaction 304 with a consumable item 306 (from a client device 302 corresponding to a user account for a user) and an interaction time 308 for the user interaction 304. Indeed, in one or more embodiments, the consumption cadence modeling system 106 identifies a consumption of the consumable item 306 through the user interaction 304. Moreover, in reference to FIG. 3, the consumption cadence modeling system 106 utilizes the consumable item 306 with a user database 310 to identify one or more users that have previously consumed the consumable item 306.

In addition, in reference to FIG. 3, the consumption cadence modeling system 106 also utilizes user attributes 312 (from the client device 302 corresponding to the user account for the user) to further identify the one or more users that have previously consumed the consumable item 306 and share one or more user attributes with the user account for the user (e.g., are similar to the user account for the user). As shown in FIG. 3, based on the consumable item 306 and the user attributes 312, the consumption cadence modeling system 106 identifies users 314 from the user database 310 and corresponding historical user consumption data 316. In one or more embodiments, the historical user consumption data 316 relates to historical consumption activity with the consumable item 306 by the users 314.

As further shown in FIG. 3, the consumption cadence modeling system 106 utilizes the historical user consumption data 316 with a consumption cadence model 318 to determine a predicted consumption cadence 326 (that is customized for the user account corresponding to the client device 302 to consume the consumable item 306). For example, FIG. 3 illustrates the consumption cadence modeling system 106 utilizing the interaction time 308 to determine a target time frame 320. Then, as shown in FIG. 3, the consumption cadence modeling system 106 utilizes the target time frame 320 with the historical user consumption data 316 to identify a subset of historical user consumption data 322 that represents user consumption activity within the target time frame 320. Then, as further shown in FIG. 3, the consumption cadence modeling system 106 utilizes the subset of historical user consumption data 322 with an analysis engine 324 (within the consumption cadence model 318) to determine a predicted consumption cadence 326 (for the user account corresponding to the client device 302).

In one or more embodiments, the consumption cadence modeling system 106 identifies users that have previously consumed a consumable item and are similar to a user that interacted with the consumable item (e.g., based on user attributes). For example, the consumption cadence modeling system 106 selects users from a user database that include associations with a particular consumable item (e.g., the consumable item consumed by the interacting user). In certain instances, the consumption cadence modeling system 106 identifies users that include data indicating a previous consumption (or other interaction) with the consumable item. As an example, the consumption cadence modeling system 106 identifies users that correspond to data in the database that indicate that the users have previously purchased a consumable item, are scheduled to consume a consumable item, subscribed to a consumable item, downloaded a consumable item, and/or accessed a consumable item.

In addition, in one or more embodiments, the consumption cadence modeling system 106 also utilizes user attributes of the interacting user to identify (or further filter) the one or more users. Indeed, in one or more embodiments, the consumption cadence modeling system 106 identifies one or more users based on user attributes corresponding to a user account, such as, but not limited to, demographic data corresponding to the user account, geographic data corresponding to the user account, time-zone data corresponding to the user account, consumption history corresponding to the user account, and/or client device information corresponding to the client device associated with the user account. For instance, the consumption cadence modeling system 106 utilizes user attributes to identify the one or more users that have previously consumed a consumable item that are similar to the interacting user. In particular, the consumption cadence modeling system 106 utilizes the user attributes to identify similar users to the interacting users utilizing approaches, such as, but not limited to, user attribute matching and/or a user similarity machine learning model.

To illustrate, in some cases, the consumption cadence modeling system 106 matches user attributes of the interacting user to user attributes of the users from a user database (that have associations with a particular consumable item). In some instances, the consumption cadence modeling system 106 identifies users from the user database that correspond to specific user attributes that are associated with the interacting user. For example, the consumption cadence modeling system 106 identifies a geographic location (or region) and gender of the interacting user and identifies users that include matching geographic location and gender data.

In one or more embodiments, the consumption cadence modeling system 106 utilizes a threshold number of attribute matches to identify the one or more users. For instance, the consumption cadence modeling system 106 identifies users that satisfy the threshold number of attribute matches prior to selecting the users as similar to the interacting user. To illustrate, in one or more embodiments, the consumption cadence modeling system 106 configures the threshold number of attribute matches to four (e.g., via an administrator device configuration, a user device configuration, a machine learning parameter).

Then, in some embodiments, the consumption cadence modeling system 106 compares user attributes of the interacting user to user attributes of users that have previously consumed the consumable item to determine a number of matching attributes. For instance, if an interacting user and a particular user have the matching geographic (or region) data, matching genders, matching age groups, matching languages, and matching client device operating system information, the consumption cadence modeling system 106 determines five matching attributes. Subsequently, in one or more embodiments, the consumption cadence modeling system 106 identifies the particular user as a matching user because the five matching attributes satisfy the threshold number of attribute matches (e.g., four). Although four is utilized as a threshold number of attribute matches as an example, the consumption cadence modeling system 106 utilizes various values for the threshold number of attribute matches.

Furthermore, in certain embodiments, the consumption cadence modeling system 106 utilizes user similarity machine learning models to identify the one or more users based on user attributes. For example, the consumption cadence modeling system 106 utilizes user similarity machine learning models to determine user affinities to similar consumable items, similarities between user behaviors, and/or similarities between user characteristics. Indeed, in some implementations, the consumption cadence modeling system 106 utilizes clustering-based similarity machine learning models.

For example, the consumption cadence modeling system 106 utilizes a user similarity machine learning model to cluster users based on user attributes. In particular, in one or more embodiments, the consumption cadence modeling system 106 generates clusters of users utilizing user attributes. As an example, the consumption cadence modeling system 106 represents the users as datapoints in a multidimensional space that represents one or more of the user attributes. Then, in some embodiments, the consumption cadence modeling system 106 utilizes distances between the user datapoints in the multidimensional space to cluster the users (e.g., shorter distances between user datapoints indicates a higher similarity whereas a greater distance indicates a lower similarity). Then, in one or more embodiments, the consumption cadence modeling system 106 utilizes users that correspond to the same cluster (or nearest cluster) to the interacting user as the similar users.

Indeed, in some implementations, the consumption cadence modeling system 106 utilizes a Bayesian non-parametric clustering algorithm to cluster users to determine users that are similar to the interacting user. In addition, in one or more embodiments, the consumption cadence modeling system 106 utilizes the Bayesian non-parametric clustering algorithm with various combinations of user attributes to determine the user clusters. As an example, in some embodiments, the consumption cadence modeling system 106 can utilize a Bayesian non-parametric clustering approach, as described in Peter Orbanz and Yee Whye Teh, Bayesian Nonparametric Models, Encyclopedia of Machine Learning, https://www.stats.ox.ac.uk/~teh/research/npbayes/OrbTeh2010a.pdf (2010), which is hereby incorporated by reference in its entirety.

Furthermore, in one or more embodiments, the consumption cadence modeling system 106 utilizes a variety of clustering algorithms as the user similarity machine learning model such as, but not limited to, k-means clustering, mean-shift clustering, density based spatial clustering, gaussian-based clustering, and/or hierarchical clustering. Although one or more embodiments illustrate the consumption cadence modeling system 106 utilizing a clustering-based user similarity machine learning model, the consumption cadence modeling system 106, in some implementations, utilizes a variety of machine learning approaches to determine similarities between users (or match user attributes) such as, but not limited to, record linking approaches, models that calculate Euclidean distances between users, and/or neural networks that generate match probabilities between users.

Furthermore, as mentioned above, in one or more embodiments, the consumption cadence modeling system 106 also identifies (or retrieves) historical user consumption data for the identified one or more users. For example, the consumption cadence modeling system 106 retrieves historical user consumption data that indicates historical user interactions (e.g., consumptions, views, saves) with a particular consumable item. As an example, for a particular user, the consumption cadence modeling system 106 identifies consumption events related to a consumable item from the particular user, the time of consumption for each of the consumption events, and/or other attributes of the consumption event (e.g., date, time, weather, monetary value of the consumption event). Indeed, as described above, the consumption cadence modeling system 106, in one or more embodiments, identifies historical user consumption data that includes, but is not limited to, a number of times a user has consumed a particular consumable item, the quantity of consumable items of a particular type previously consumed, times (or dates) of consumption, a consumption frequency, consumable items previously interacted with by the particular user, and/or previously saved (or bookmarked) consumable items.

Additionally, in one or more embodiments, the consumption cadence modeling system 106 also identifies the one or more user that previously consumed the consumable item by identifying that the interacting user associated with the user account interacting with the consumable item has previously consumed the consumable item. For example, the consumption cadence modeling system 106 identifies the interacting user and historical user consumption data for the interacting user as part of the one or more users that have previously consumed the particular consumable item. Indeed, in some instances, the consumption cadence modeling system 106 utilizes the interacting user and historical user consumption data for the interacting user with the other identified users and their historical user consumption data to determine the predicted consumption cadence for the interacting user.

Furthermore, in one or more embodiments, the consumption cadence modeling system 106 determines a target time frame utilizing an interaction time of user interaction with a consumable item. For instance, the consumption cadence modeling system 106 selects a target time frame that corresponds to the interaction time of the user’s consumption of the consumable item. In certain instances, the consumption cadence modeling system 106 identifies a target time frame that meets the particular interaction time.

As an example, upon identifying that the interaction time of a user interaction with a consumable item is December 20^{th}, the consumption cadence modeling system 106 identifies a target time frame of winter, which is associated with a time range from November to February. As another example, upon identifying that the interaction time of a user interaction with a consumable item is June 10^{th}, the consumption cadence modeling system 106 identifies a target time frame of summer, which is associated with a time range from June to August. Furthermore, as another example, upon identifying that the interaction time of a user interaction with a consumable item is November 24^{th}, the consumption cadence modeling system 106 identifies a target time frame of Thanksgiving week, which is associated with a time range from November 21^{st} to November 28^{th}.

Furthermore, the consumption cadence modeling system 106, in some embodiments, identifies other events as target time frames. For instance, upon identifying that the interaction time of a user interaction with a consumable item is October 3^{rd}, the consumption cadence modeling system 106 identifies a target time frame of Football season, which is associated with a time range from September to January. Additionally, as another example, upon identifying that the interaction time of a user interaction with a consumable item is December 4^{th}, the consumption cadence modeling system 106 identifies a target time frame of Skiing season, which is associated with a time range from November to April.

Moreover, in some embodiments, the consumption cadence modeling system 106 identifies a category of time as a target time frame. For example, upon identifying that the interaction time of a user interaction with a consumable item is on Wednesday, the consumption cadence modeling system 106 identifies a target time frame of Weekdays, which is associated with a time range from Monday to Friday (e.g., or Weekends for Saturday and Sunday). As another example, upon identifying that the interaction time of a user interaction with a consumable item is at 9:00 PM, the consumption cadence modeling system 106 identifies a target time frame of nighttime, which is associated with a time range of 8:00 PM to 4:30 AM.

In certain instances, the consumption cadence modeling system 106 identifies a target time frame utilizing a customized target time frame received from a user account of a client device. For instance, the consumption cadence modeling system 106 receives (via a graphical user interface) selections or configurations to a target time frame from client device corresponding to a user account. Then, in one or more embodiments, the consumption cadence modeling system 106 utilizes the customized target time frame as the target time frame.

In some embodiments, the consumption cadence modeling system 106 identifies a target time frame based on one or more user attributes of the interacting user. For example, the consumption cadence modeling system 106 selects a target time frame that is relevant to an interacting user based on associations between user attributes and one or more target time frames. To illustrate, in one or more embodiments, the consumption cadence modeling system 106 determines a target time frame of Football season over a target time frame of Winter based on the interacting user corresponding to user attributes (e.g., geographic location, gender, age, selected interests) that indicate that the interacting user follows Football. In some instances, the consumption cadence modeling system 106 utilizes mappings between user attributes and target time frames to identify a target time frame that results in a high probability match (e.g., using a clustering approach and/or a neural network classification approach).

Furthermore, in one or more embodiments, the consumption cadence modeling system 106 utilizes a target time frame to identify a subset of historical user consumption data (from the historical user consumption data identified for the one or more users). For instance, the consumption cadence modeling system 106 identifies a range of time associated with an identified target time frame (e.g., December to February, June to August, Monday to Friday, 9:00 PM to 4:00 AM). Then, in one or more embodiments, the consumption cadence modeling system 106 selects (or filters) historical user consumption data that corresponds to a time that meets the range of time associated with the identified target time frame. For example, if the target time frame is winter (which is associated with the months November to February), the consumption cadence modeling system 106 selects historical user consumption data that corresponds to consumption interaction times that fall between November and February as the subset of historical user consumption data.

Additionally, in one or more implementations, the consumption cadence modeling system 106 utilizes the subset of historical user consumption data (and/or a set of historical user consumption data without a target time frame) with the consumption cadence model (e.g., using an analysis engine as shown in FIG. 3) to determine a predicted consumption cadence that is personalized for a user for a consumable item. For example, the consumption cadence modeling system 106 utilizes the subset of historical user consumption data with a statistical model (as the analysis engine) to determine the predicted consumption cadence.

As an example, in some cases, the consumption cadence modeling system 106 identifies time intervals between consumptions from the subset of historical user consumption data. Then, the consumption cadence modeling system 106 utilizes the time intervals with a statistical model to determine an average time interval as the predicted consumption cadence. In some implementations, the consumption cadence modeling system 106 determines statistical values such as, but not limited to, a moving average, a median, and/or a distribution as the predicted consumption cadence.

In one or more embodiments, the consumption cadence modeling system 106 utilizes a time series model as the consumption cadence model. For example, the consumption cadence modeling system 106 utilizes a time series model to analyze the subset of historical user consumption data and predicted time durations corresponding to initiating a subsequent consumption event from a time of an initial consumption event. To illustrate, in some embodiments, the consumption cadence modeling system 106 utilizes a time series model to determine predicted consumption cadences from historical user consumption data as described in Shiv Kumar Saini, Sunav Choudhary & Gaurush Hiranandani, Extracting Seasonal, Level, and Spike Components from a Time Series of Metrics Data, U.S. Pat. Application No. 15/804,012 (filed Nov. 6, 2017), the entire contents of which are hereby incorporated by reference.

In some instances, the consumption cadence modeling system 106 utilizes a machine learning model as the analysis engine of the consumption cadence model. For instance, the consumption cadence modeling system 106 utilizes a machine learning model to analyze the subset of historical user consumption data to generate a predicted consumption cadence for a particular user. In particular, in one or more embodiments, the consumption cadence modeling system 106 utilizes a machine learning model that, based on the subset of historical user consumption data, classifies a particular consumption cadence (as the predicted consumption cadence) for a particular user. Indeed, the consumption cadence modeling system 106 utilizes machine learning models such as, but not limited to, an LSTM model, a CNN model, and/or an RNN model.

In some cases, the consumption cadence modeling system 106 utilizes a machine learning model that utilizes a decision tree or regression function to map consumptions (and interval times between consumptions) of a consumable item from a subset of historical user consumption data. Indeed, the consumption cadence modeling system 106 utilizes the generated decision tree and/or regression function to output a predicted consumption cadence for the consumable item in relation to the particular user. Indeed, the consumption cadence modeling system 106 utilizes machine learning models such as, but not limited to, decision tree models, linear regression models, and/or random forest models.

In some instances, the consumption cadence modeling system 106 also trains a machine learning model to determine predicted consumption cadences. For example, the consumption cadence modeling system 106 utilizes training data that includes historical user consumption data (as ground truth data) for historical consumption behaviors of particular users. Then, the consumption cadence modeling system 106 utilizes user attributes of a particular and a consumable item with a machine learning model to determine a predicted consumption cadence for consuming the consumable item by the particular user. Then, the consumption cadence modeling system 106 compares the predicted consumption cadence to an actual consumption cadence for the particular user from the historical consumption behavior of the particular user (e.g., the ground truth data) to generate a loss (e.g., a cross entropy or logarithmic loss, a mean squared error, an L2 norm loss).

Then, the consumption cadence modeling system 106, in one or more embodiments, utilizes the determined loss to train the machine learning model. In particular, in some instances, the consumption cadence modeling system 106 utilizes the determined loss to adjust parameters of a machine learning model to increase the accuracy of the predicted consumption cadence for the particular user. For instance, the consumption cadence modeling system 106 utilizes multiple iterations of determined losses and adjusted parameters to train a machine learning model to accurately determine predicted consumption cadences for users.

In some instances, the consumption cadence modeling system 106 utilizes a feedback loop to train the machine learning model. In particular, in one or more embodiments, the consumption cadence modeling system 106 utilizes user interactions with predicted consumption cadences to train the machine learning model. For instance, the consumption cadence modeling system 106 utilizes user interactions as feedback to adjust parameters to train a machine learning model to accurately determine predicted consumption cadences for users.

Indeed, in one or more embodiments, the consumption cadence modeling system 106 utilizes the consumption cadence model to determine a predicted consumption cadence that is customized for a user account to consume the consumable item. In one or more embodiments, the consumption cadence modeling system 106 determines a predicted consumption cadence that reflects a pattern of activity that the consumption cadence modeling system 106 determines as accurate for the interacting user from the user account. For instance, the consumption cadence modeling system 106 determine a predicted consumption cadence that reflects a likely consumption time for a user (e.g., a time interval per consumption of a consumable item). As an example, the consumption cadence modeling system 106 determines a predicted consumption cadence for a user that indicates that the specific user will consume a consumable item (e.g., a product or service) every 2.5 months (or a variety of other time values).

As described above, in some cases, the consumption cadence modeling system 106 determines a predicted consumption cadence that is specific to a target time frame. As an example, the consumption cadence modeling system 106 determines a predicted consumption cadence for a user that indicates that the user will consume a consumable item every 2.5 months during the winter season and every 1.5 months in the summer season. As described in greater detail below, the consumption cadence modeling system 106 presents an indicator for the predicted consumption cadence with selectable options to schedule a consumption of the particular consumable item at the time intervals indicated by the predicted consumption cadence (e.g., in relation to FIGS. 5-9).

As mentioned above, in one or more embodiments, the consumption cadence modeling system 106 determines predicted consumption cadences from user interactions with multiple consumable items. Indeed, in one or more embodiments, the consumption cadence modeling system 106 utilizes user interactions with multiple consumable items to identify whether a consumption of a particular consumable item influences a consumption cadence of another consumable item. For instance, the consumption cadence modeling system 106 models a pairwise interaction between consumable items by determining whether the consumption of the consumable items is correlated and then, whether the consumption of the consumable items occurs at a repeatable consumption cadence (e.g., a consumption pattern).

For example, FIG. 4 illustrates the consumption cadence modeling system 106 utilizing relationships between consumable item consumptions to determine a predicted consumption cadence for one (or both) of the consumable items. Indeed, FIG. 4 illustrates the consumption cadence modeling system 106 determining a consumption cadence for a consumable item based on relations between historical user interactions with the consumable item and another consumable item when a user interacts with the consumable item and the other consumable item.

As shown in FIG. 4, the consumption cadence modeling system 106 identifies a first user interaction 404 corresponding to a first consumable item 406 at an interaction time 408. Additionally, as shown in FIG. 4, the consumption cadence modeling system 106 identifies a second user interaction 410 corresponding to a second consumable item 412 at an interaction time 414. In some embodiments, the consumption cadence modeling system 106 identifies the first user interaction 404 and the second user interaction 410 simultaneously (e.g., identifying a user interaction that includes a consumption of both the first and second consumable items 406 and 412). In some cases, the consumption cadence modeling system 106 identifies the first user interaction 404 and the second user interaction 410 within a threshold interval of time (e.g., the first and second consumable items 406 and 412 are consumed within a threshold time interval of 5 minutes, 10 minutes, 1 day, 1 week).

Then, in one or more embodiments, the consumption cadence modeling system 106 identifies one or more users from a user database 418 that have previously consumed the first and second consumable items 406 and 412 based on the first user interaction 404 with the first consumable item 406 and the second user interaction 410 with the second consumable item 412 within a threshold time 420. For instance, the consumption cadence modeling system 106 identifies users from the user database 418 that correspond to user consumption data 424 that indicates a consumption of the first consumable item 406 and the second consumable item 412 within the threshold time 420 (e.g., within a threshold time interval of 5 minutes, 10 minutes, 1 day, 1 week).

Additionally, in some embodiments, the consumption cadence modeling system 106 also utilizes the user attributes 416 of the user account corresponding to the client device 402 to further select the one or more users from the user database 418 (e.g., by comparing the user attributes 416 to the user data 422). For instance, the consumption cadence modeling system 106 compares the user attributes of the interacting user with the one or more users in the user database 418 as described above (e.g., in relation to FIG. 3). Indeed, as shown in FIG. 4, the consumption cadence modeling system 106 identifies users 426 with historical user consumption data for the first consumable item 428 and historical user consumption data for the second consumable item 430 based on the user attributes 416 and the first and second consumable items 406 and 412.

Then, as shown in FIG. 4, the consumption cadence modeling system 106 utilizes the historical user consumption data for the first consumable item 428 and the historical user consumption data for the second consumable item 430 with a consumption cadence model 432 to determine a predicted consumption cadence for the first consumable item 434. In addition, as shown in FIG. 4, in some embodiments, the consumption cadence modeling system 106 also utilizes the historical user consumption data for the first consumable item 428 and the historical user consumption data for the second consumable item 430 with a consumption cadence model 432 to determine a predicted consumption cadence for the second consumable item 436.

In one or more embodiments, the consumption cadence modeling system 106 identifies one or more users that have previously consumed a first and second consumable item within a threshold time. In particular, in one or more embodiments, the consumption cadence modeling system 106 determines a threshold time that represents a time between two or more consumptions of consumable items that define the consumptions as related consumptions. For example, the consumption cadence modeling system 106 utilizes the threshold time to determine that interactions from a user with two or more consumable items were related. As an example, the consumption cadence modeling system 106 can identify that a user has previously consumed two consumable items (e.g., the online purchase of shampoo and conditioner) and that the consumptions satisfy a threshold time (e.g., the shampoo and conditioner were purchased within 24 hours of each other) to indicate a relationship. In some instances, the consumption cadence modeling system 106 determines the threshold time from, but not limited to, a configuration provided by an administrator device, user device configuration, and/or a machine learning parameter).

In some cases, the consumption cadence modeling system 106 identifies the one or more users that have previously consumed a first and second consumable item at the same time. For example, the consumption cadence modeling system 106 utilizes a threshold time of 0 to indicate that the consumption of the first and second consumable item happened simultaneously. As an example, the consumption cadence modeling system 106 identifies one or more users that have consumed the first and second consumable item within the same consumption event (e.g., an online purchase of shampoo and conditioner within the same online purchase order).

Upon identifying one or more users from a user database that have previously consumed the first and second consumable item within a threshold time and are similar to the interacting user based on user attributes (as described above), the consumption cadence modeling system 106 identifies historical user consumption data of the one or more users corresponding to the first and second consumable item. In one or more embodiments, the consumption cadence modeling system 106 utilizes the historical user consumption data of the one or more users that corresponds to consumptions of the two consumable items within the threshold time. In some instances, the consumption cadence modeling system 106 utilizes the historical user consumption data of the one or more users that corresponds to various consumptions of the first and/or second consumable items (e.g., regardless of the time between the consumptions) from users that have at least one consumption event of the two consumable items that satisfies the threshold time. Furthermore, in some cases, the consumption cadence modeling system 106 further identifies a subset from the historical user consumption data according to a target time frame (as described above).

Then, as described above (e.g., in relation to FIG. 3), the consumption cadence modeling system 106 utilizes the consumption cadence model to analyze the historical user consumption data that corresponds to consumptions of two (or more) consumable items to determine a predicted consumption cadence for the one or more of the consumable items. For instance, the consumption cadence modeling system 106 utilizes the consumption cadence model as a statistical model (as described above) to determine an average consumption cadence (or other statistical value) from the historical user consumption data that corresponds to consumptions of two (or more) consumable items as the predicted consumption cadence for the one or more consumable items. In some cases, the consumption cadence modeling system 106 utilizes the consumption cadence model as a machine learning model (as described above) to analyze the historical user consumption data that corresponds to consumptions of two (or more) consumable items to determine the predicted consumption cadence for the one or more consumable items. Moreover, in certain implementations, the consumption cadence modeling system 106 further utilizes a subset of historical user consumption data (based on a target time frame) with the consumption cadence model to determine a predicted consumption cadence for the one or more consumable items.

In one or more implementations, the consumption cadence modeling system 106 utilizes the consumption cadence model to determine a predicted consumption cadence for a consumable item (and one or more additional consumable items) that is customized for a user account to consume the consumable item. In particular, in one or more embodiments, the consumption cadence modeling system 106 determines a predicted consumption cadence that reflects a pattern of activity that the consumption cadence modeling system 106 determines as accurate for the interacting user consumption behavior of the one or more consumable items. Indeed, using the historical user consumption data related to both a first and second consumable item (as described with reference to FIG. 4), the consumption cadence modeling system 106 determines predicted consumption cadences that reflect the consumption relationships between the two or more consumable items.

As an example, the consumption cadence modeling system 106 determines a predicted consumption cadence for a user that indicates that a specific user will consume a first consumable item (e.g., a product or service) every 3.5 months (or a variety of other time values) when the user has also consumed a second consumable item. To illustrate, in some instances, the consumption cadence modeling system 106 determines that a specific user consumes a first consumable item (e.g., shampoo) every 3.5 months when the specific user also consumes a second consumable item (e.g., a conditioner, a second shampoo). Indeed, in some embodiments, the consumption cadence modeling system 106 determines a predicted consumption cadence that is different from a predicted consumption cadence when a user consumes a consumable item independently from a second consumable item (e.g., a single consumption event for a single consumable item versus a consumption event that includes two or more consumable items).

As another example, the consumption cadence modeling system 106 identifies that a specific user purchases a daytime face lotion and a nighttime face lotion. Then, for example, the consumption cadence modeling system 106 identifies one or more users (that are similar to the specific user) that have also purchased a daytime face lotion and a nighttime face lotion within a threshold time. Moreover, in one or more embodiments, the consumption cadence modeling system 106 utilizes the historical user consumption data from these one or more users to determine a predicted consumption cadence for the specific user consuming the daytime face lotion when a nighttime face lotion is a related purchase.

To illustrate, in some cases, the consumption cadence modeling system 106 determines that the specific user will consume the daytime face lotion every 4 months when the nighttime face lotion is a related purchase. In some embodiments, the consumption cadence modeling system 106 further determines that the specific user will consume the daytime face lotion every 2 monthswhen the nighttime face lotion is not a related purchase. Indeed, in some embodiments, the consumption cadence modeling system 106 determines the different consumption cadence when using historical user consumption data of users that previously consumed the daytime face lotion regardless of relation to the nighttime face lotion.

As an additional example, the consumption cadence modeling system 106 identifies that a specific user purchases road bicycle tires and gravel bicycle tires. Then, for instance, the consumption cadence modeling system 106 identifies one or more users (that are similar to the specific user) that have also purchased road bicycle tires and gravel bicycle tires within a threshold time. Furthermore, in one or more embodiments, the consumption cadence modeling system 106 utilizes the historical consumption data from these one or more users to determine a predicted consumption cadence for the specific user consuming the road bicycle tires when the gravel bicycle tires are a related purchase.

To continue the example, in some cases, the consumption cadence modeling system 106 determines that the specific user will consume the road bicycle tires every 1.5 years when the gravel bicycle tires are a related purchase. In one or more embodiments, the consumption cadence modeling system 106 further determines that the specific user will consume the road bicycle tires every 5 months when the gravel bicycle tires are not a related purchase. Indeed, in some cases, the consumption cadence modeling system 106 determines the different consumption cadence when using historical user consumption data of users that previously consumed the road bicycle tires regardless of relation to the gravel bicycle tires.

Although one or more embodiments (in relation to FIG. 4) describe the consumption cadence modeling system 106 determining one or more predicted consumption cadences for two consumable items that are related, in some implementations, the consumption cadence modeling system 106 determines predicted consumption cadences for various numbers of consumable items that are related. In particular, in some instances, the consumption cadence modeling system 106 identifies that four consumable items are consumed within a threshold time and utilizes historical user consumption data from one or more users that previously consumed the four consumable items within a threshold time with the consumption cadence model to determine predicted consumption cadences for the four consumable items. In addition, in one or more implementations, the consumption cadence modeling system 106 further utilizes a target time frame to determine one or more predicted consumption cadences from two or more consumable items that are related for a specific target time frame (as described above).

As mentioned above, in one or more implementations, the consumption cadence modeling system 106 displays, within a graphical user interface, an indicator for one or more predicted consumption cadences and/or selectable options to schedule consumption of consumable items according to the one or more predicted consumption cadences. For instance, FIG. 5 illustrates the consumption cadence modeling system 106 displaying an indicator for a predicted consumption cadence. In addition, FIG. 5 also illustrates the consumption cadence modeling system 106 displaying a selectable option to schedule consumption of a consumable item according to a predicted consumption cadence.

As shown in FIG. 5, the consumption cadence modeling system 106 provides, for display within a graphical user interface 502 of a client device 504, an indicator 506 for a predicted consumption cadence that is customized for a user account to consume a consumable item (e.g., a shampoo product). As shown in FIG. 5, the consumption cadence modeling system 106 displays an indicator that dynamically represents a changing predicted consumption cadence (e.g., on a sliding bar). As further shown in FIG. 5, the consumption cadence modeling system 106 also displays the target time frame 508 utilized for the predicted consumption cadence in the indicator 506. Indeed, the consumption cadence modeling system 106, in one or more embodiments, displays an updated predicted consumption cadence (e.g., by changing the sliding indicator 506) upon changing (or determining) an updated target time frame 508.

As further shown in FIG. 5, the consumption cadence modeling system 106 also provides a description for the indicator 506 that presents the predicted consumption cadence. As shown in FIG. 5, the consumption cadence modeling system 106 indicates what is represented by the personalized schedule (e.g., the predicted consumption cadence). Moreover, also shown in FIG. 5, the consumption cadence modeling system 106 also provides a description to indicate that the indicator 506 is dynamic and changes upon determination of a subsequent predicted consumption cadence and/or subsequent target time frame.

Although FIG. 5 illustrates the consumption cadence modeling system 106 utilizing a sliding bar indicator (e.g., the indicator 506) to display a dynamic predicted consumption cadence for a consumable item, the consumption cadence modeling system 106, in one or more embodiments, utilizes a variety of user elements. For instance, the consumption cadence modeling system 106 utilizes meter- or bar-based user element for the predicted consumption cadence. In some implementations, the consumption cadence modeling system 106 utilizes chart-based user elements to present the predicted consumption cadence.

As further shown in FIG. 5, the consumption cadence modeling system 106 also provides for display, within the graphical user interface 502, a selectable option 510 (e.g., a radio button) to schedule a consumption of the consumable item according to the predicted consumption cadence presented in the indicator 506. For instance, upon receiving an interaction with the selectable option 510, the consumption cadence modeling system 106 generates a trigger that consumes the consumable item within the user account at a time interval determined based on the predicted consumption cadence from the indicator 506 (e.g., every two weeks). Then, upon determining that the time interval (e.g., 2 weeks) has elapsed, in some embodiments, the consumption cadence modeling system 106 automatically initiates a consumption event for the consumable item for the user account (e.g., automatically purchases the shampoo). Although FIG. 5 illustrates the selectable option 510 as a radio button, the consumption cadence modeling system 106, in one or more embodiments, utilizes a variety of selectable option user elements such as, but not limited to, a button and/or a hover element.

In some cases, the consumption cadence modeling system 106 displays an indicator for a quantity of consumable items to consume at a scheduled purchase (e.g., every 3 weeks, every 6 weeks) to match a predicted consumption cadence as a rate of consumption. For instance, the consumption cadence modeling system 106 displays, within a graphical user interface, a number of consumable items to purchase (e.g., a quantity) at a fixed, scheduled time (e.g., every month, every week) to match a rate of consumption indicated by a predicted consumption cadence. As an example, when the consumption cadence modeling system 106 determines a predicted consumption cadence of every 1 week, the consumption cadence modeling system 106 presents an indicator that represents a quantity of consumable items to purchase per month (or another time period) to match the predicted consumption cadence of every 1 week (e.g., 4 of the consumable items every month).

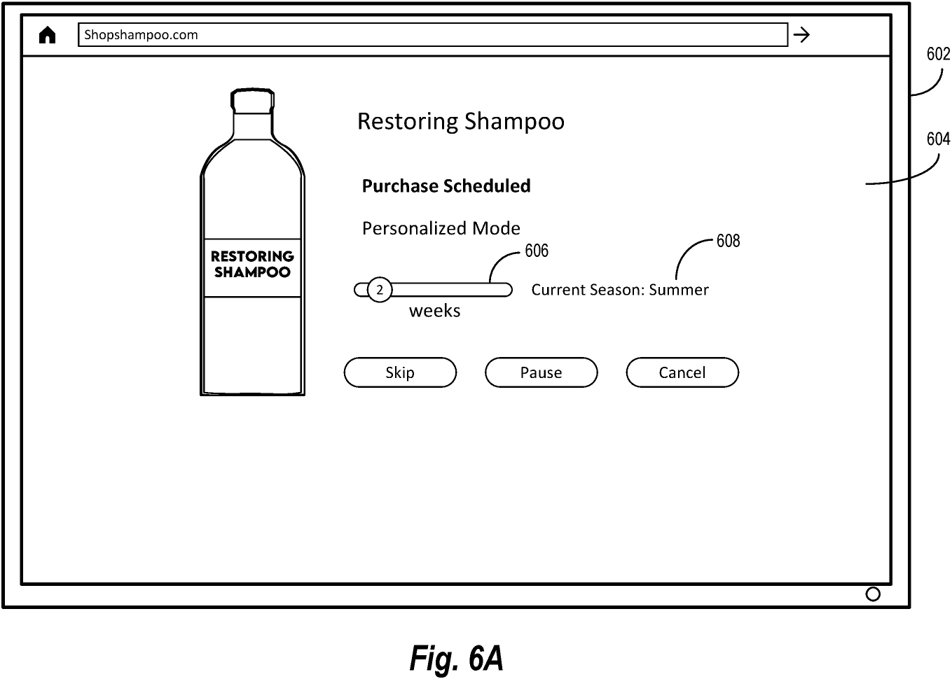

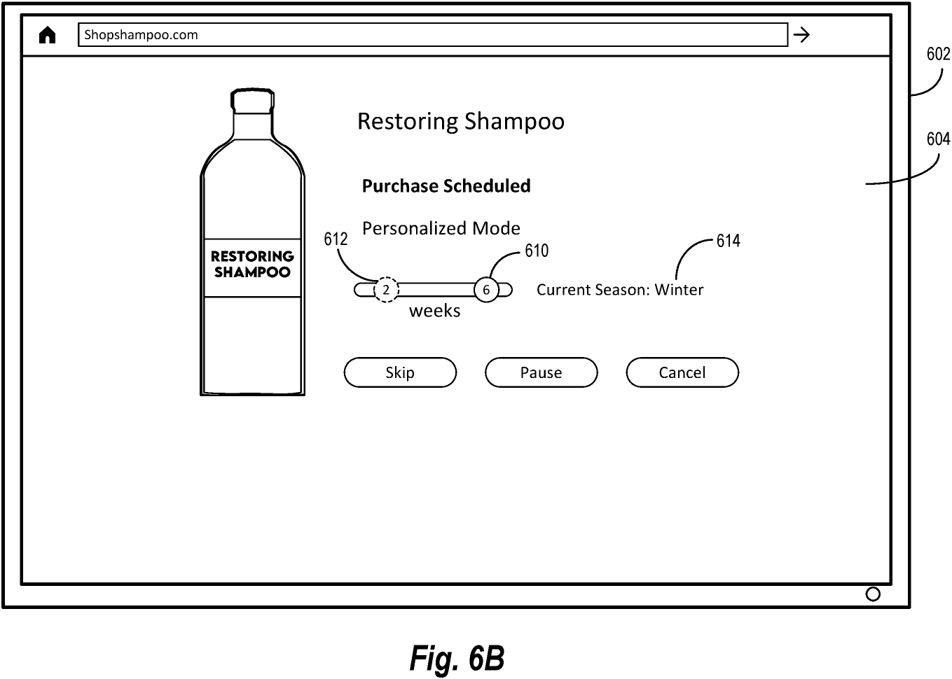

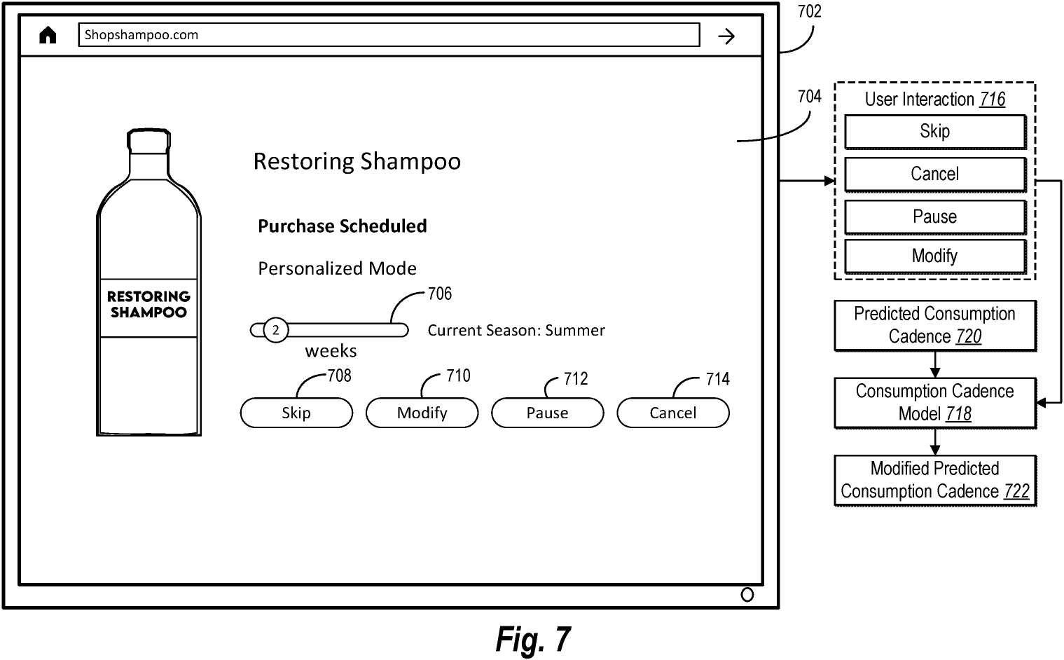

As mentioned above, the consumption cadence modeling system 106, in one or more embodiments, dynamically updates the indicator that presents a predicted consumption cadence. In particular, FIGS. 6A and 6B illustrate the consumption cadence modeling system 106 updating the indicator that presents the predicted consumption cadence. In some cases, the consumption cadence modeling system 106 determines an updated consumption cadence to present within an indicator based on updates to a target time frame, change in historical user consumption data, and/or subsequent user behavior (e.g., as described below in relation to FIG. 7).

For example, as shown in FIG. 6A, the consumption cadence modeling system 106 provides, for display within a graphical user interface 604 of a client device 602, an indicator 606 for the predicted consumption cadence and an indicator 608 for a target time frame for the predicted consumption cadence. Then, as shown by the transition from FIGS. 6A to 6B, the consumption cadence modeling system 106 displays, within the graphical user interface 604 of the client device 602, an updated indicator 610 to display an updated predicted consumption cadence (e.g., from 2 weeks to 6 weeks) for the consumable item and an updated target time frame 614. In addition, as shown in FIG. 6B, the consumption cadence modeling system 106 also presents an indicator 612 to represent the previously predicted consumption cadence for the consumable item. Although a specific change is demonstrated by the embodiments in FIGS. 6A and 6B, the consumption cadence modeling system 106, in one or more embodiments, displays indicators to present a variety of changes of the predicted consumption cadence for a consumable item.

In some instances, the consumption cadence modeling system 106 identifies or determines a change in predicted consumption cadence and, subsequently, transmits an electronic communication (e.g., an e-mail, a notification, an SMS message) to indicate the change in consumption cadence. Moreover, in some implementations, the consumption cadence modeling system 106 displays within the electronic communication (or upon receiving a user interaction with a link within the electronic communication) an indicator to indicate the change in predicted consumption cadence. For instance, the consumption cadence modeling system 106 provides for display, within the electronic communication (or upon receiving a user interaction with a link within the electronic communication), an indicator as described above (e.g., in relation to FIG. 6B) upon determining a change in predicted consumption cadence.

In some embodiments, the consumption cadence modeling system 106 automatically adjusts a consumption schedule based on a determined change in predicted consumption cadence. For instance, the consumption cadence modeling system 106 generates a trigger to automatically perform a consumption event in accordance with the updated consumption cadence upon determining a change in predicted consumption cadence. In some cases, the consumption cadence modeling system 106 further transmits an electronic communication (e.g., an e-mail, a notification, an SMS message) to a user account to indicate the change in schedule to consume the consumable item.

As also mentioned above, the consumption cadence modeling system 106, in one or more embodiments, modifies a predicted consumption cadence customized for a user account based on user interactions from the user account. For instance, FIG. 7 illustrates the consumption cadence modeling system 106 modifying a predicted consumption cadence based on user interactions corresponding to a user account. As shown in FIG. 7, the consumption cadence modeling system 106 provides for display, within a graphical user interface 704 of a client device 702, an indicator 706 for a predicted consumption cadence for a consumable item. In addition, as shown in FIG. 7, the consumption cadence modeling system 106 also provides for display, within the graphical user interface 704, selectable options 708, 710, 712, and 714.

Indeed, in one or more embodiments, the consumption cadence modeling system 106 detects a user interaction with one or more of the selectable options 708, 710, 712, and 714. Then, as shown in FIG. 7, the consumption cadence modeling system 106 utilizes the user interactions 716 (e.g., one or more of a selection of a skip, cancel, pause, and/or modify option) to modify a predicted consumption cadence. As shown in FIG. 7, the consumption cadence modeling system 106 utilizes the predicted consumption cadence 720 with a consumption cadence model 718 and the user interaction 716 to generate a modified predicted consumption cadence 722.

In one or more embodiments, the consumption cadence modeling system 106 receives a user interaction corresponding to a skip option (e.g., selectable option 708) to indicate that the user associated with the user account requested a skip of the subsequent scheduled consumption of the consumable item. For example, based on receiving the user interaction to select a skip option, the consumption cadence modeling system 106 cancels the subsequent scheduled consumption of the consumable item (based on the predicted consumption cadence) while keeping future scheduled consumptions intact (e.g., scheduled consumptions after the subsequent scheduled consumption). As an example, when a consumption is scheduled on December 1^{st} for a predicted consumption cadence of once per month and upon receiving an indication to skip a subsequent scheduled consumption, the consumption cadence modeling system 106 cancels the scheduled consumption on December 1^{st} but maintains the next scheduled consumption on January 1^{st} (and the months onward).

In some embodiments, the consumption cadence modeling system 106 receives a user interaction corresponding to a cancel option (e.g., selectable option 714) to indicate that the user associated with the user account requested to cancel scheduled consumptions of the consumable item based on the predicted consumption cadence (e.g., a cancellation interaction). For instance, based on receiving the user interaction to select a cancel option, the consumption cadence modeling system 106 cancels the scheduled consumption of the consumable item at the predicted consumption cadence. As an example, when a consumption is scheduled on December 1^{st} for a predicted consumption cadence of once per month and upon receiving an indication to cancel the scheduled consumptions, the consumption cadence modeling system 106 cancels the scheduled consumptions (December 1^{st} and the ongoing months).

In one or more implementations, the consumption cadence modeling system 106 receives a user interaction corresponding to a pause option (e.g., selectable option 712) to indicate that the user associated with the user account requested to pause scheduled consumptions of the consumable item based on the predicted consumption cadence. To illustrate, in some embodiments, based on receiving the user interaction to select a pause option, the consumption cadence modeling system 106 pauses the scheduled consumption of the consumable item at the predicted consumption cadence. Indeed, in one or more embodiments, the consumption cadence modeling system 106 pauses the scheduled consumptions at the rate of the predicted consumption cadence until a user request to resume the scheduled consumptions is received from client device.

In some cases, the consumption cadence modeling system 106 receives a user interaction corresponding to a modify option (e.g., selectable option 710) to indicate that the user associated with the user account requested to modify the predicted consumption cadence. In particular, in one or more embodiments, the consumption cadence modeling system 106 receives a modification request to change the predicted consumption cadence (e.g., change a prediction consumption cadence of 1 month to 1.5 months). Upon receiving a request to modify the predicted consumption cadence, the consumption cadence modeling system 106, in one or more embodiments, the consumption cadence modeling system 106 modifies the predicted consumption cadence and one or more scheduled consumptions based on the predicted consumption cadence.

In some instances, the consumption cadence modeling system 106 utilizes an observed consumption of the consumable item from a user associated with the user account to modify the predicted consumption cadence. For example, the consumption cadence modeling system 106 identifies additional consumptions of a user related to the consumable item to determine that a change in the predicted consumption cadence. Then, in some embodiments, the consumption cadence modeling system 106 modifies the predicted consumption cadence (and/or updates the consumption cadence model to update the predicted consumption cadence) according to the observed consumptions. As an example, upon scheduling consumptions for a consumable item based on a predicted consumption cadence of once per month, the consumption cadence modeling system 106 tracks (or observes) future consumptions of the consumable item from the user. In some cases, when the consumption cadence modeling system 106 observes that the user is consuming additional quantities of the consumable item in between the scheduled consumptions (e.g., the user purchases one more of the consumable item in between the scheduled time), the consumption cadence modeling system 106 adjusts the predicted consumption cadence (and/or the scheduled consumptions) based on the observed consumptions.

In one or more embodiments, the consumption cadence modeling system 106 utilizes the above mentioned user interactions to modify an existing predicted consumption cadence. In some cases (as shown in FIG. 7), the consumption cadence modeling system 106 utilizes the above mentioned user interactions to modify a subsequent predicted consumption cadence (e.g., via modifications to the consumption cadence model). For instance, in some cases (as shown in FIG. 7), the consumption cadence modeling system 106 utilizes a user interaction with the consumption cadence model to adjust the consumption cadence model and its subsequently predicted consumption cadences.

For example, the consumption cadence modeling system 106 adjusts weights or parameters associated with a statistical-based consumption cadence model to reflect the user interactions from the user. Indeed, in one or more embodiments, the consumption cadence modeling system 106 utilizes user interactions to affect an average (or other statistical value) calculated from historical user consumption data. Moreover, in some embodiments, the consumption cadence modeling system 106 utilizes the user interactions to generate a loss for a machine learning-based consumption cadence model and/or adjust parameters (or weights) associated with the machine learning-based consumption cadence model such that the machine learning-based consumption cadence model outputs accurate predicted consumption cadences.

Although one or more embodiments describe the consumption cadence modeling system 106 modifying a predicted consumption cadence for a consumable item, in some instances, the consumption cadence modeling system 106 modifies the predicted consumption cadences of multiple consumable items. In particular, in some instances, the consumption cadence modeling system 106 receives user interactions (e.g., a request to cancel, modify, skip, pause, and/or consumption observations) with one or more consumable items. Then, in one or more embodiments, the consumption cadence modeling system 106 modifies a predicted consumption cadence for a consumable item that was based on historical user consumption data of the multiple consumable items (e.g., as described in relation to FIG. 4). Indeed, in one or more implementations, the consumption cadence modeling system 106 modifies the predicted consumption cadence for a consumable item based on one or more user interactions with another (related) consumable item.

As an example, the consumption cadence modeling system 106 determines a predicted consumption cadence for a first consumable item (and a second consumable item) when both consumable items are consumed within a threshold time (e.g., as described in relation to FIG. 4). Then, in one or more embodiments, the consumption cadence modeling system 106 receives a user interaction (e.g., a request to cancel, modify, skip, pause, and/or consumption observations) with the second consumable item. In certain instances, the consumption cadence modeling system 106 utilizes the user interactions with the second consumable item to modify the predicted consumption cadence for the first consumable item.

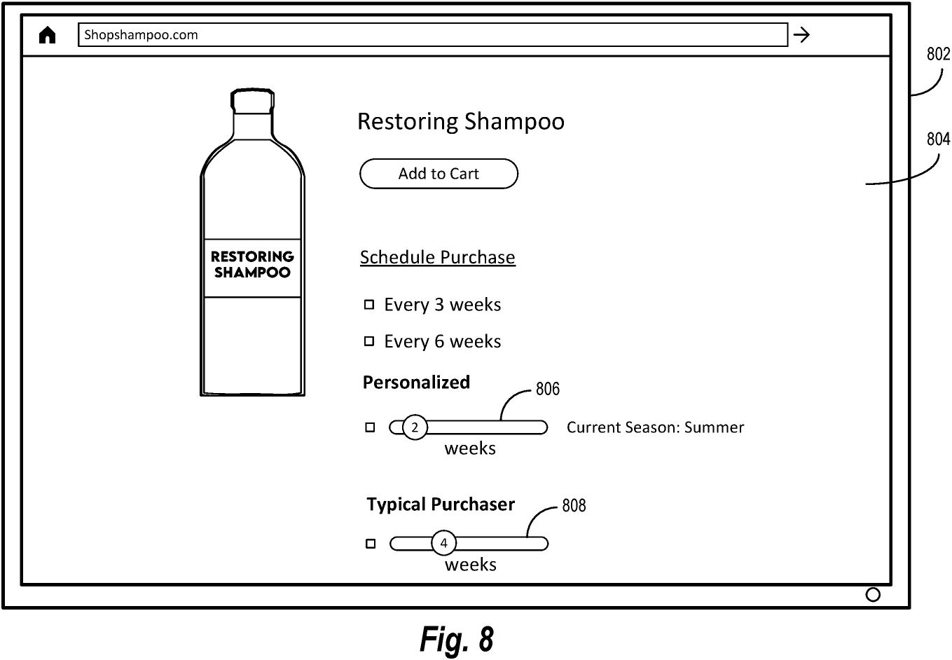

Furthermore, in one or more embodiments, the consumption cadence modeling system 106 displays, within a graphical user interface of a client device, a graphic comparing a predicted consumption cadence (that is customized for the user account) to a generic consumption cadence for a set of other users to consume the consumable item. For example, FIG. 8 illustrates the consumption cadence modeling system 106 displaying a graphic that compares the predicted consumption cadence for a consumable item to a generic consumption cadence for a set of other users to consume the consumable item. As shown in FIG. 8, the consumption cadence modeling system 106 provides for display, within a graphical user interface 804 of the client device 802, an indicator 806 to present a predicted consumption cadence (determined in accordance with one or more implementations). Furthermore, as shown in FIG. 8, the consumption cadence modeling system 106 provides for display, within the graphical user interface 804, an indicator 808 to present a generic consumption cadence for a set of other users to consume the consumable item.

For instance, the consumption cadence modeling system 106 determines a generic consumption cadence for a set of other users that is not personalized for an interacting user. In one or more embodiments, the consumption cadence modeling system 106 determines a generic consumption cadence for a set of other users to consume the consumable item by utilizing a set of users that previously consumed the consumable item without utilizing data points on user attributes and/or a target time frame. In particular, in one or more embodiments, the consumption cadence modeling system 106 utilizes a most commonly selected default scheduling cadence (e.g., a selection from the generic schedule options) as the generic consumption cadence.

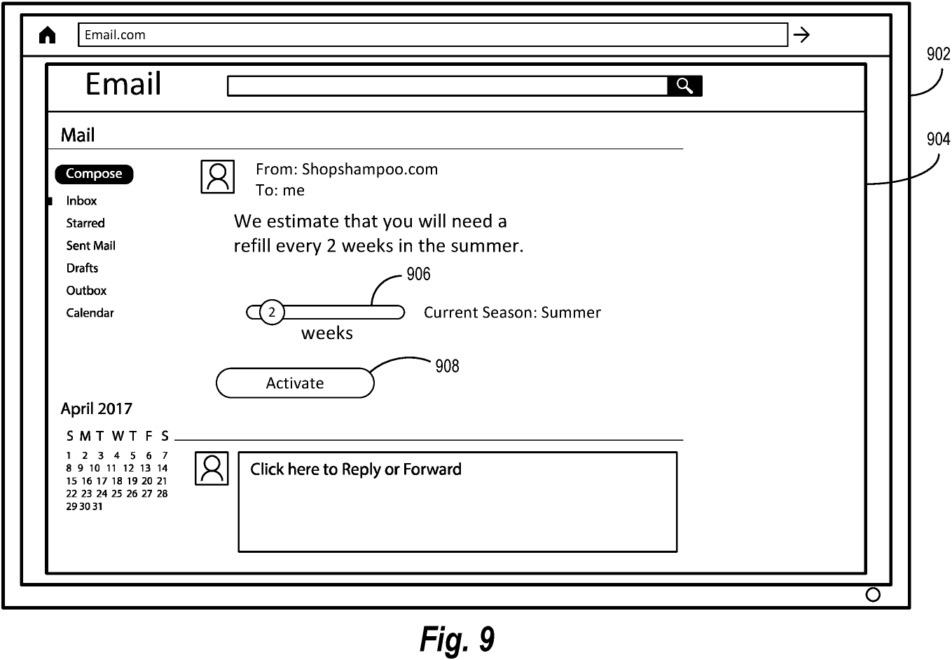

Additionally, in some embodiments, the consumption cadence modeling system 106 also transmits electronic communications utilizing a predicted consumption cadence. For example, FIG. 9 illustrates the consumption cadence modeling system 106 transmitting an electronic communication utilizing a predicted consumption cadence. As shown in FIG. 9, the consumption cadence modeling system 106 transmits an e-mail, as displayed within a graphical user interface 904 of a client device 902, that indicates a predicted consumption cadence utilizing an indicator 906. Furthermore, as shown in FIG. 9, the consumption cadence modeling system 106 also transmits the e-mail, as displayed within the graphical user interface 904, to provide a selectable option 908 to activate the predicted consumption cadence (as indicated by the indicator 906).

In one or more embodiments, the consumption cadence modeling system 106 determines a predicted consumption cadence for a consumable item consumed by the user within historical user consumption data. Then, upon determining the predicted consumption cadence for the consumable item, the consumption cadence modeling system 106 transmits an electronic communication to a client device of the user to provide options to activate a scheduled consumption based on the predicted consumption cadence. For instance, the consumption cadence modeling system 106 transmits electronic communications for a variety of determined consumption cadences (e.g., for one or more consumable items) in accordance with one or more embodiments herein.

In addition, in one or more embodiments, the consumption cadence modeling system 106 receives data indicating a user interaction with a selectable option to activate a predicted consumption cadence (e.g., the selectable option 908). Upon receiving the user interaction with the selectable option to activate, in one or more embodiments, the consumption cadence modeling system 106 schedules a consumption of the consumable item for the corresponding user based on the predicted consumption cadence. Although FIG. 9 illustrates the consumption cadence modeling system 106 transmitting an email, the consumption cadence modeling system 106, in some embodiments, utilizes a variety of electronic communications, such as, but not limited to, an SMS message, a push notification, and/or an instant message.

Additionally, although FIG. 9 illustrates the consumption cadence modeling system 106 transmitting an electronic communication that displays a selectable option to activate the predicted consumption cadence, the consumption cadence modeling system 106, in one or more embodiments, provides a variety of selectable options (as described above) within an electronic communication. For example, the consumption cadence modeling system 106 displays a selectable option to modify a predicted consumption cadence (e.g., a modify-cadence option) within a transmitted electronic communication. Additionally, in some embodiments, upon receiving a user input (from a client device) to modify (or modifying) a predicted consumption cadence via the modify-cadence option, the consumption cadence modeling system 106 modifies the predicted consumption cadence for the user account based on the user input.

In some cases, the consumption cadence modeling system 106 transmits an electronic communication to display selectable options for a feedback loop of the consumption cadence model. As an example, the consumption cadence modeling system 106 transmits an electronic communication to display options to indicate whether a scheduled consumption was sufficient (e.g., “running low?”, “was the scheduled purchase enough?”, “ready to purchase another?”). Then, the consumption cadence modeling system 106 receives user interactions with the options as feedback information to adjust a consumption cadence model (e.g., train and/or adjust parameters).

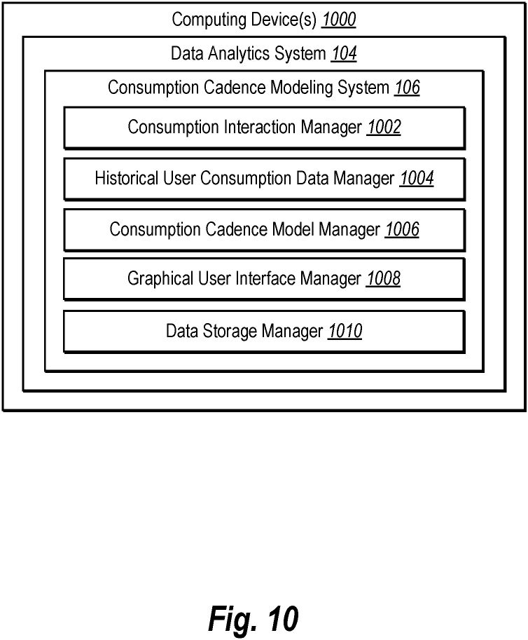

Turning now to FIG. 10, additional detail will be provided regarding components and capabilities of one or more implementations of the consumption cadence modeling system. In particular, FIG. 10 illustrates an example consumption cadence modeling system 106 executed by a computing device 1000 (e.g., server device(s) 102 or the client devices 110a- 110n). As shown by the implementation of FIG. 10, the computing device 1000 includes or hosts the data analytics system 104 and the consumption cadence modeling system 106. Furthermore, as shown in FIG. 10, the consumption cadence modeling system 106 includes a consumption interaction manager 1002, a historical user consumption data manager 1004, a consumption cadence model manager 1006, a graphical user interface manager 1008, and a data storage manager 1010.

As just mentioned, and as illustrated in the implementation of FIG. 10, the consumption cadence modeling system 106 includes the consumption interaction manager 1002. For instance, the consumption interaction manager 1002 receives one or more interactions with consumable items displayed within a graphical user interface of a client device as described above (e.g., in relation to FIGS. 2-4). In addition, in some embodiments, the consumption interaction manager 1002 also receives one or more interactions with selectable options corresponding to a predicted consumption cadence (e.g., an activate option, a cancel option, a modify option, a pause option, a skip option) as described above (e.g., in relation to FIGS. 5-9).

Furthermore, as shown in FIG. 10, the consumption cadence modeling system 106 includes the historical user consumption data manager 1004. For example, the historical user consumption data manager 1004 identifies one or more users that have previously consumed a consumable item based on a consumable item and/or user attributes corresponding to an interacting user as described above (e.g., in relation to FIGS. 3 and 4). Additionally, in some embodiments, the historical user consumption data manager 1004 also utilizes target time frames to filter and/or determine a subset of historical user consumption data for the one or more users as described above (e.g., in relation to FIGS. 3 and 4).

Moreover, as shown in FIG. 10, the consumption cadence modeling system 106 includes the consumption cadence model manager 1006. For instance, the consumption cadence model manager 1006 utilizes historical user consumption data with a consumption cadence model to determine a predicted consumption cadence for a particular user as described above (e.g., in relation to FIGS. 3, 4, and 7). Additionally, the consumption cadence model manager 1006 utilizes a statistics-based and/or a machine learning-based model to determine a predicted consumption cadence as described above (e.g., in relation to FIGS. 3, 4, and 7).

Furthermore, as shown in FIG. 10, the consumption cadence modeling system 106 includes the graphical user interface manager 1008. For example, the graphical user interface manager 1008 displays one or more (dynamic) indicators for predicted consumption cadences as described above (e.g., in relation to FIGS. 5-9). Moreover, the graphical user interface manager 1008 displays one or more selectable options to schedule consumption based on and/or modify a predicted consumption cadence as described above (e.g., in relation to FIGS. 5-9).

In addition, as shown in FIG. 10, the consumption cadence modeling system 106 includes the data storage manager 1010. In one or more implementations the data storage manager 1010 is implemented by one or more memory devices. Furthermore, in some implementations, the data storage manager 1010 maintains data to perform one or more functions of the consumption cadence modeling system 106. For example, the data storage manager 1010 includes historical user consumption data, consumable item data, consumption cadence model data, and/or predicted consumption cadence data for user accounts.

Each of the components 1002-1010 of the computing device 1000 (e.g., the computing device 110a implementing the consumption cadence modeling system 106), as shown in FIG. 10, may be in communication with one another using any suitable communication technologies. It will be recognized that although components 1002-1010 of the computing device 1000 (or computer device) are shown to be separate in FIG. 10, any of components 1002-1010 may be combined into fewer components, such as into a single facility or module, divided into more components, or configured into different components as may serve a particular embodiment.

The components 1002-1010 of the computing device 1000 can comprise software, hardware, or both. For example, the components 1002-1010 can comprise one or more instructions stored on a computer-readable storage medium and executable by processor of one or more computing devices. When executed by the one or more processors, the computer-executable instructions of the consumption cadence modeling system 106 (e.g., via the computing device 1000) can cause a client device and/or server device to perform the methods described herein. Alternatively, the components 1002-1010 and their corresponding elements can comprise hardware, such as a special purpose processing device to perform a certain function or group of functions. Additionally, the components 1002-1010 can comprise a combination of computer-executable instructions and hardware.

Furthermore, the components 1002-1010 of the consumption cadence modeling system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1010 may be implemented as a stand-alone application, such as a desktop or mobile application. Furthermore, the components 1002-1010 may be implemented as one or more web-based applications hosted on a remote server. The components 1002-1010 may also be implemented in a suite of mobile device applications or “apps.” To illustrate, the components 1002-1010 may be implemented in an application, including but not limited to, ADOBE EXPEIRENCE PLATFORM, ADOBE ANALYTICS CLOUD, ADOBE ANALYTICS, ADOBE AUDIENCE MANAGER, ADOBE CAMPAIGN, and ADOBE TARGET. “ADOBE,” “ADOBE EXPEIRENCE PLATFORM,” “ADOBE ANALYTICS CLOUD,” “ADOBE ANALYTICS,” “ADOBE AUDIENCE MANAGER,” “ADOBE CAMPAIGN,” and “ADOBE TARGET” are either registered trademarks or trademarks of Adobe Inc. in the United States and/or other countries.

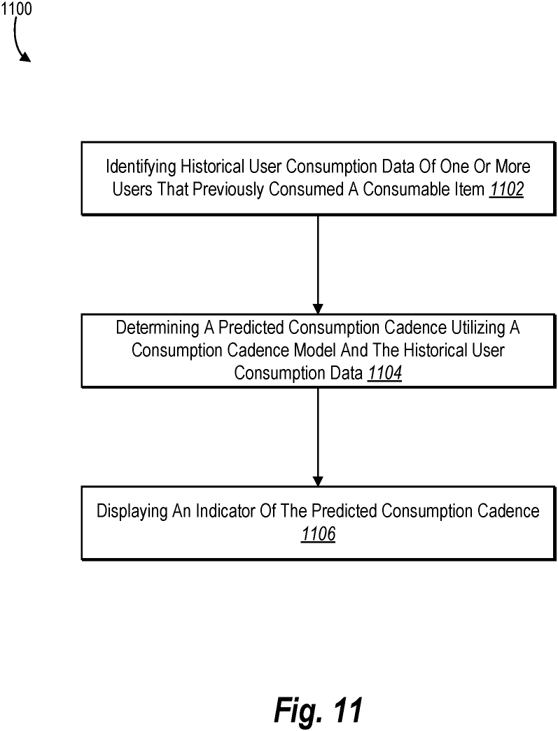

FIGS. 1-10, the corresponding text, and the examples provide a number of different methods, systems, devices, and non-transitory computer-readable media of the consumption cadence modeling system 106. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

As mentioned above, FIG. 11 illustrates a flowchart of a series of acts 1100 for determining a predicted consumption cadence utilizing a consumption cadence model in accordance with one or more implementations. While FIG. 11 illustrates acts according to one embodiment, alternative embodiments may omit, add to, reorder, and/or modify any of the acts shown in FIG. 11. The acts of FIG. 11 can be performed as part of a computer-implemented method. Alternatively, a non-transitory computer-readable medium can comprise instructions that, when executed by one or more processors, cause a computing device to perform the acts of FIG. 11. In some embodiments, a system can perform the acts of FIG. 11.

As shown in FIG. 11, the series of acts 1100 include an act 1102 of identifying historical user consumption data of one or more user that have previously consumed a consumable item. In particular, in one or more embodiments, the act 1102 includes detecting, from a client device associated with a user account, a user interaction with a graphical representation of a consumable item at an interaction time. Furthermore, in some instances, the act 1102 includes identifying one or more users that previously consumed a consumable item based on one or more user attributes corresponding to a user account.

In addition, in some embodiments, the act 1102 includes determining (a subset of) historical user consumption data of one or more users consuming a consumable item (during a target time frame corresponding to an interaction time). In some instances, the act 1102 includes identify one or more users that previously consumed a consumable item by identifying that a user associated with a user account previously consumed the consumable item. Furthermore, in some embodiments, the act 1102 includes identifying one or more users that previously consumed a consumable item by identifying a set of additional users based on one or more user attributes corresponding to a user account utilizing demographic data corresponding to the user account, geographic data corresponding to the user account, time-zone data corresponding to the user account, consumption history corresponding to the user account, or client device information corresponding to the client device associated with the user account.

In one or more embodiments, the act 1102 includes detecting, from a client device associated with a user account, one or more user interactions with one or more graphical representations of a first consumable item and a second consumable item. In addition, in some embodiments, the act 1102 includes identifying one or more users that previously consumed, within a threshold time frame, a first consumable item and a second consumable item based on one or more user attributes corresponding to a user account. Furthermore, in some embodiments, the act 1102 includes determining (a subset of) historical user consumption data of one or more users consuming a first consumable item and a second consumable item during a target time frame. For example, the act 1102 includes identifying one or more users that previously consumed a first consumable item and a second consumable item by identifying that a user associated with a user account previously consumed the first consumable item and the second consumable item within a threshold time frame.

For instance, a target time frame includes a spring season, a summer season, an autumn season, or a winter season. In some cases, the act 1102 includes utilizing a customized set of days, a customized set of weeks, or a customized set of months for a user account as a target time frame. In some instances, the act 1102 includes identifying, from a client device associated with a user account, a display of a graphical representation of a consumable item.

As also shown in FIG. 11, the series of acts 1100 include an act 1104 of determining a predicted consumption cadence utilizing a consumption cadence model and the historical user consumption data. In particular, in one or more embodiments, the act 1104 includes determining, utilizing a consumption cadence model, a predicted consumption cadence customized for a user account to consume a consumable item based on a subset of historical user consumption data of one or more users consuming the consumable item during a target time frame corresponding to an interaction time. In some cases, the act 1104 includes determining a predicted consumption cadence customized for a user account based on user consumption data of a user consuming the consumable item.

In certain implementations, the act 1104 includes determining an observed consumption cadence of a user associated with a user account consuming a consumable item based on user consumption data of the user consuming the consumable item. Furthermore, in some embodiments, the act 1104 includes modifying a predicted consumption cadence based on an observed consumption cadence of a consumable item for a user account.

Additionally, in some embodiments, the act 1104 includes determining a predicted consumption cadence by utilizing a consumption cadence model to generate an average consumption cadence for a consumable item based on a subset of the historical user consumption data of one or more users consuming the consumable item. In some cases, the act 1104 includes utilizing a machine learning model as a consumption cadence model. For example, a machine learning model-based consumption cadence model includes a long short-term memory model, a convolutional neural network model, or a recurrent neural network model.

Furthermore, in some embodiments, the act 1104 includes detecting, from a client device, an additional user interaction with a graphical representation of a consumable item during a different interaction time corresponding to a different target time frame. In addition, in some instances, the act 1104 includes determining, utilizing a consumption cadence model, a different predicted consumption cadence customized for a user account to consume a consumable item based on a different subset of historical user consumption data of one or more users consuming the consumable item during a different target time frame.

Additionally, in one or more implementations, the act 1104 includes determining, utilizing a consumption cadence model, a predicted consumption cadence customized for a user account to consume a first consumable item based on a subset of historical user consumption data of one or more users consuming the first consumable item and a second consumable item during a target time frame. Furthermore, in some cases, the act 1104 includes determining, utilizing a consumption cadence model, an additional predicted consumption cadence customized for a user account to consume a second consumable item. In some instances, the act 1104 includes determining a predicted consumption cadence customized for a user account to consume a first consumable item based on historical user consumption data of a user consuming the first consumable item and a second consumable item.

In certain implementations, the act 1104 includes determining a predicted consumption cadence by utilizing a consumption cadence model to generate an average consumption cadence for a first consumable item based on a subset of the historical user consumption data of one or more users consuming the first consumable item and a second consumable item.

Additionally, in some embodiments, the act 1104 includes determining an observed consumption cadence of a user associated with a user account consuming a first consumable item and a second consumable item based on user consumption data of the user consuming the first consumable item and the second consumable item. Furthermore, in some cases, the act 1104 includes modifying a subsequent predicted consumption cadence customized for a user account to consume a first consumable item based on an observed consumption cadence.

In some instances, the act 1104 includes detecting a cancellation interaction by a particular client device associated with a user account cancelling a scheduled consumption of a first consumable item according to a predicted consumption cadence and modifying a subsequent predicted consumption cadence customized for a user account to consume the first consumable item based on the cancellation interaction. Furthermore, in some embodiments, the act 1104 includes transmitting, to a client device, an electronic communication comprising a modify-cadence option to modify a predicted consumption cadence. Then, in some instances, the act 1104 includes receiving, from a client device, user input modifying a predicted consumption cadence via a modify-cadence option and modifying the predicted consumption cadence for the user account based on the user input.

In addition to (or in alternative to) the acts above, the series of acts 1100 can also include a step for determining a customized consumption cadence for a user account based on historical user consumption data for the consumable item. For example, the acts and algorithms described above in relation to FIGS. 3 or 4 (i.e., the acts 302-326 from FIG. 3 or the acts 402-436 from FIG. 4) can comprise the corresponding acts and algorithms (i.e., structure) for performing a step for determining a customized consumption cadence for a user account based on historical user consumption data for the consumable item.

As further shown in FIG. 11, the series of acts 1100 include an act 1106 of displaying an indicator of the predicted consumption cadence. In particular, in some embodiments, the act 1106 includes providing, for display within a graphical user interface of a client device, an indicator of a predicted consumption cadence customized for a user account according to a target time frame and a selectable option to schedule consumption of the consumable item according to the predicted consumption cadence. Moreover, in some cases, the act 1106 includes providing, for display within a graphical user interface of a client device, an indicator of a predicted consumption cadence customized for a user account according to a target time frame and a selectable option to schedule consumption of a first consumable item according to the predicted consumption cadence.

Furthermore, in some instances, the act 1106 includes displaying within a graphical user interface of a client device, a graphic comparing a predicted consumption cadence customized for a user account to a generic consumption cadence for a set of other users to consume a consumable item. In some cases, the act 1106 includes displaying on a client device with a graphical representation of a consumable item, a graphic comparing a customized consumption cadence for a user account to an average consumption cadence for a set of other users to consume the consumable item. Furthermore, in some embodiments, the act 1106 includes displaying on a client device with a graphical representation of a consumable item, a selectable option to cancel a scheduled consumption of a consumable item according to a customized consumption cadence.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., computing device 1000, server device(s) 102, and/or client devices 110a-110n). In one or more implementations, the computing device 1200 may be a mobile device (e.g., a mobile telephone, a smartphone, a PDA, a tablet, a laptop, a camera, a tracker, a watch, a wearable device, etc.). In some implementations, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other implementations. Furthermore, in certain implementations, the computing device 1200 includes fewer components than those shown in FIG. 12. Components of the computing device 1200 shown in FIG. 12 will now be described in additional detail.

In particular implementations, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (“HDD”), flash memory, a Universal Serial Bus (“USB”) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (“NIC”) or network adapter for communicating with an Ethernet or other wire-based network or a wireless NIC (“WNIC”) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example implementations thereof. Various implementations and aspects of the invention(s) are described with reference to details discussed herein, and the accompanying drawings illustrate the various implementations. The description above and drawings are illustrative of the invention and are not to be construed as limiting the invention. Numerous specific details are described to provide a thorough understanding of various implementations of the present invention.

The present invention may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
one or more memory devices comprising a consumption cadence model that predicts consumption cadences from historical user consumption data; and
one or more processors configured to cause the system to:
detect, from a client device associated with a user account, a user interaction with a graphical representation of a consumable item at an interaction time;
identify one or more users that previously consumed the consumable item based on one or more user attributes corresponding to the user account;
determine, utilizing the consumption cadence model, a predicted consumption cadence customized for the user account to consume the consumable item based on a subset of the historical user consumption data of the one or more users consuming the consumable item during a target time frame corresponding to the interaction time; and
provide, for display within a graphical user interface of the client device, an indicator of the predicted consumption cadence customized for the user account according to the target time frame and a selectable option to schedule consumption of the consumable item according to the predicted consumption cadence.

2. The system of claim 1, wherein the one or more processors are further configured to cause the system to utilize a spring season, a summer season, an autumn season, or a winter season as the target time frame.

3. The system of claim 1, wherein the one or more processors are further configured to cause the system to utilize a customized set of days, a customized set of weeks, or a customized set of months for the user account as the target time frame.

4. The system of claim 1, wherein the one or more processors are further configured to cause the system to:
identify the one or more users that previously consumed the consumable item by identifying that a user associated with the user account previously consumed the consumable item; and
determine the predicted consumption cadence customized for the user account based on user consumption data of the user consuming the consumable item.

5. The system of claim 1, wherein the one or more processors are further configured to cause the system to identify the one or more users that previously consumed the consumable item by identifying a set of additional users based on the one or more user attributes corresponding to the user account utilizing demographic data corresponding to the user account, geographic data corresponding to the user account, time-zone data corresponding to the user account, consumption history corresponding to the user account, or client device information corresponding to the client device associated with the user account.

6. The system of claim 1, wherein the one or more processors are further configured to cause the system to:
determine an observed consumption cadence of a user associated with the user account consuming the consumable item based on user consumption data of the user consuming the consumable item; and
modify the predicted consumption cadence based on the observed consumption cadence of the consumable item for the user account.

7. The system of claim 1, wherein the one or more processors are further configured to cause the system to determine the predicted consumption cadence by utilizing the consumption cadence model to generate an average consumption cadence for the consumable item based on the subset of the historical user consumption data of the one or more users consuming the consumable item.

8. The system of claim 1, wherein the consumption cadence model comprises a long short-term memory model, a convolutional neural network model, or a recurrent neural network model.

9. The system of claim 1, wherein the one or more processors are further configured to:
detect, from the client device, an additional user interaction with the graphical representation of the consumable item during a different interaction time corresponding to a different target time frame; and
determine, utilizing the consumption cadence model, a different predicted consumption cadence customized for the user account to consume the consumable item based on a different subset of historical user consumption data of the one or more users consuming the consumable item during the different target time frame.

10. The system of claim 1, wherein the one or more processors are further configured to provide, for display within the graphical user interface of the client device, a graphic comparing the predicted consumption cadence customized for the user account to a generic consumption cadence for a set of other users to consume the consumable item.

11. A non-transitory computer-readable medium storing instructions that, when executed by at least one processor, cause a computing device to:
detect, from a client device associated with a user account, one or more user interactions with one or more graphical representations of a first consumable item and a second consumable item;
identify one or more users that previously consumed, within a threshold time frame, the first consumable item and the second consumable item based on one or more user attributes corresponding to the user account;
determine, utilizing a consumption cadence model, a predicted consumption cadence customized for the user account to consume the first consumable item based on a subset of historical user consumption data of the one or more users consuming the first consumable item and the second consumable item during a target time frame; and
provide, for display within a graphical user interface of the client device, an indicator of the predicted consumption cadence customized for the user account according to the target time frame and a selectable option to schedule consumption of the first consumable item according to the predicted consumption cadence.

12. The non-transitory computer-readable medium of claim 11, further comprising instructions that, when executed by the at least one processor, cause the computing device to determine, utilizing the consumption cadence model, an additional predicted consumption cadence customized for the user account to consume the second consumable item.

13. The non-transitory computer-readable medium of claim 11, further comprising instructions that, when executed by the at least one processor, cause the computing device to:
identify the one or more users that previously consumed the first consumable item and the second consumable item by identifying that a user associated with the user account previously consumed the first consumable item and the second consumable item within the threshold time frame; and
determine the predicted consumption cadence customized for the user account to consume the first consumable item based on historical user consumption data of the user consuming the first consumable item and the second consumable item.

14. The non-transitory computer-readable medium of claim 11, further comprising instructions that, when executed by the at least one processor, cause the computing device to determine the predicted consumption cadence by utilizing the consumption cadence model to generate an average consumption cadence for the first consumable item based on the subset of the historical user consumption data of the one or more users consuming the first consumable item and the second consumable item.

15. The non-transitory computer-readable medium of claim 11, further comprising instructions that, when executed by the at least one processor, cause the computing device to:
determine an observed consumption cadence of a user associated with the user account consuming the first consumable item and the second consumable item based on user consumption data of the user consuming the first consumable item and the second consumable item; and
modify a subsequent predicted consumption cadence customized for the user account to consume the first consumable item based on the observed consumption cadence.

16. The non-transitory computer-readable medium of claim 11, further comprising instructions that, when executed by the at least one processor, cause the computing device to:
detect a cancellation interaction by a particular client device associated with the user account cancelling a scheduled consumption of the first consumable item according to the predicted consumption cadence; and
modify a subsequent predicted consumption cadence customized for the user account to consume the first consumable item based on the cancellation interaction.

17. The non-transitory computer-readable medium of claim 11, further comprising instructions that, when executed by the at least one processor, cause the computing device to:
transmit, to the client device, an electronic communication comprising a modify-cadence option to modify the predicted consumption cadence;
receive, from the client device, user input modifying the predicted consumption cadence via the modify-cadence option; and
modify the predicted consumption cadence for the user account based on the user input.

18. A computer-implemented method comprising:
identifying, from a client device associated with a user account, a display of a graphical representation of a consumable item;
performing a step for determining a customized consumption cadence for the user account based on historical user consumption data for the consumable item; and
providing, for display on the client device with the graphical representation of the consumable item, an indication of the customized consumption cadence for the user account and a selectable option to schedule consumption of the consumable item according to the customized consumption cadence.

19. The computer-implemented method of claim 18, further comprising providing, for display on the client device with the graphical representation of the consumable item, a graphic comparing the customized consumption cadence for the user account to an average consumption cadence for a set of other users to consume the consumable item.

20. The computer-implemented method of claim 18, further comprising providing, for display on the client device with the graphical representation of the consumable item, a selectable option to cancel a scheduled consumption of the consumable item according to the customized consumption cadence.
